(19) United States
(12) Patent Application Publication
(10) Pub. No.: US 2011/0144780 A1
(43) Pub. Date: Jun. 16, 2011

(54) TIMING CONTROL DEVICE AND TIMING CONTROL METHOD

(76) Inventors: Hiromu Ueshima, Shiga (JP); Naoto Arakawa, Shiga (JP)

(21) Appl. No.: 12/532,260

(22) PCT Filed: Mar. 26, 2008
(86) PCT No.: PCT/JP2008/000742

§ 371 Date: Jun. 9, 2010

(30) Foreign Application Priority Data
Mar. 27, 2007 (JP) 2007-080816

(51) Int. Cl. G06F 17/00

(52) U.S. Cl. 700/94

(57) ABSTRACT

An audio visual apparatus 1 displays animation in which a character 102 strikes drum objects 106R and 106L with sticks 104R and 104L respectively. In this case, the audio visual apparatus 1 performs frequency analysis of audio signals AL_{E}, AR_{E} as input from outside, predicts occurrence timing of a future beat, and starts to swing the stick 104L or 104R down earlier by the time T_{A} than the occurrence of the beat. Herewith, it is possible to synchronize the strikes of the drum objects 106L and 106R by the sticks 104L and 104R with the beat of the music.

### TECHNICAL FIELD

The present invention relates to a timing controller and the related arts for analyzing an external input audio signal and controlling timing for setting an event based on a result of the analysis.

### BACKGROUND ART

The musical scale recognition method by the present applicant is disclosed in Patent Document 1. In accordance with this musical scale recognition method, a musical scale is recognized by comparing external input voice with a specified frequency component (a musical scale) input of which is expected.

Patent Document 1: Japanese Patent Published Application No. 2002-341886

### DISCLOSURE OF THE INVENTION

### Problem to be Solved by the Invention

As described above, there are other possible applications of the technique which receives an audio signal from outside, analyzes the audio signal, and performs processing in accordance with a result of the analysis.

It is therefore an object of the present invention to provide a timing controller and the related arts capable of analyzing an external input audio signal to effect a predetermined result at a base point of periodic repetition of the audio signal which will occur in future while executing real-time processing.

### Solution of the Problem

In accordance with a first aspect of the present invention, a timing controller, comprising: a predicting unit operable to analyze an audio signal as input from outside, detect cyclic repetition of the audio signal, and predict occurrence timing of a base point of the cyclic repetition; a setting unit operable to set an event on the basis of the occurrence timing as predicted; a controlling unit operable to perform a predetermined control in response to the set event to effect a predetermined result at the occurrence timing as predicted.

In accordance with this configuration, the occurrence timing of the base point (e.g., a beat) of the cyclic repetition of the external input audio signal is predicted, then the event is set based on the result of the prediction, and thereby it is possible to perform the real-time processing. Therefore, it is possible to be small the scale of the storage means such as a memory, and reduce the cost because a device for playing back the stored audio signal is not required, in comparison with the case where the audio signal is played back and the event is set after storing temporarily and analyzing the audio signal. Incidentally, in the case where the input audio signal is temporarily stored and analyzed, subsequently, the audio signal is played back, and the event is set, a delay occurs because of the storing, analyzing, and playing back, and therefore it is not the real-time processing.

Also, since the occurrence timing of the base point of the cyclic repetition of the external input audio signal is predicted, while performing the real-time processing, it is possible to effect the predetermined result at the future base point of the cyclic repetition of the external input audio signal.

Incidentally, the term “audio signal” means a signal which represents audio such as music, acousmato, voice, and sound. Also, the cyclic repetition of the audio signal is, for example, a beat, a rhythm, and so on of the audio signal. The base point of the cyclic repetition of the audio signal means a starting point of one cycle of the audio signal, and the base point of one cycle coincides with an ending point of a previous one cycle. The predetermined result means that an object to be controlled becomes a predetermined state. The term “predetermined state” contains a predetermined appearance, a predetermined position, predetermined sound, and so on.

In this timing controller, the setting unit sets the each event so that a time from time when the predetermined result is effected until time when the predetermined result is next effected coincides with a cycle of the cyclic repetition of the audio signal.

In the above timing controller, the predetermined control is control of a predetermined image, and wherein the controlling unit controls the predetermined image in response to the set event to allow the predetermined image to effect the predetermined result at the occurrence timing as predicted.

In accordance with this configuration, it is possible to allow the predetermined image to effect the predetermined result at the future base point of the cyclic repetition of the audio signal while performing the real-time processing.

In this timing controller, the controlling unit controls change of the predetermined image in response to the set event to effect the predetermined result at the occurrence timing as predicted, and wherein the change of the predetermined image includes change of a position and/or an appearance. Incidentally, the term “appearance” is used as a term including shape, pattern, and color.

In this timing controller, the setting unit determines at least one of change-start timing, appearance timing on a screen, change-start position, a trajectory, velocity, and acceleration of the predetermined image on the basis of the occurrence timing as predicted, and sets the event on the basis of a result of the determination. Incidentally, the term “change” is used as a term including change of a position and change of an appearance. The term “appearance” is used as a term including shape, pattern, and color.

Also, in the above timing controller, the predetermined control is control of predetermined sound, and wherein the controlling unit controls the predetermined sound in response to the set event to allow the predetermined sound to effect the predetermined result at the occurrence timing as predicted.

In accordance with this configuration, it is possible to allow the predetermined sound to effect the predetermined result at the future base point of the cyclic repetition of the audio signal while performing the real-time processing.

In this timing controller, the setting unit determines at least one of output-start timing and change-start timing on the basis of the occurrence timing as predicted, and sets the event on the basis of a result of the determination.

Further, in the above timing controller, the predetermined control is control of an external device and/or an external computer program, and wherein the controlling unit controls the external device and/or the external computer program in response to the set event to effect the predetermined result at the occurrence timing as predicted.

In accordance with this configuration, it is possible to allow the external device and/or the external computer program to effect the predetermined result at the future base point of the cyclic repetition of the audio signal while performing the real-time processing.

Still further, in the above timing controller, the predetermined control is control of a predetermined thing or a predetermined material, and wherein the controlling unit controls the predetermined thing or the predetermined material in response to the set event to effect the predetermined result at the occurrence timing as predicted.

In accordance with this configuration, it is possible to allow the predetermined thing or the predetermined material to effect the predetermined result at the future base point of the cyclic repetition of the audio signal while performing the real-time processing. Incidentally, the term “material” is used as a term including a solid, liquid, and gas.

In this timing controller, the controlling unit controls change of the predetermined thing or the predetermined material in response to the set event to effect the predetermined result at the occurrence timing as predicted, and wherein the change of the predetermined thing or the predetermined material includes change of a position and/or an appearance. Incidentally, the term “appearance” is used as a term including shape, pattern, and color.

In this timing controller, the setting unit determines at least one of change-start timing, appearance timing, change-start position, a trajectory, velocity, and acceleration of the predetermined thing or the predetermined material on the basis of the occurrence timing as predicted, and sets the event on the basis of a result of the determination. Incidentally, the term “change” is used as a term including change of a position and change of an appearance. The term “appearance” is used as a term including shape, pattern, and color.

In the above timing controller, the setting unit sets the event a predetermined time prior to the occurrence timing as predicted, and wherein the controlling unit starts the predetermined control in response to the set event to effect the predetermined result after elapse of the predetermined time.

In accordance with this configuration, a time (referred to as “activation time”) from time when the control is started until time when the predetermined result is effected is certainly a certain time, i.e., a constant time without depending on the speed (e.g., tempo) of the cyclic repetition of the audio signal. As the result, even the cyclic repetition of the audio signal differs, it is possible to perform the common control during the activation time and at the time when the activation time has elapsed, and therefore the constant expression and effect can be supplied without depending on the cyclic repetition of the audio signal.

For example, if the audio signal is music, the activation time is constant regardless of the tempo of the music. Thus, even the tempo of the music differs, it is possible to perform the common control during the activation time and at the time when the activation time has elapsed, and therefore the constant expression and effect can be supplied without depending on the tempo of the music.

In this timing controller, the predetermined control is control of a predetermined image, wherein the controlling unit starts change of the predetermined image in response to the set event to allow the predetermined image to effect the predetermined result after elapse of the predetermined time, and wherein a process of the change of the predetermined image does not depend on the audio signal.

In accordance with this configuration, since the process of the change of the predetermined image during the activation time and the predetermined result do not depend on the audio signal, even the cyclic repetition of the audio signal differs, the constant expression and effect can be supplied by the predetermined image.

For example, when the audio signal is music, even the tempo of the music differs, since the process of the change of the predetermined image during the activation time and the predetermined result are common, the constant expression and effect can be supplied by the predetermined image without depending on the tempo of the music.

Incidentally, the term “change” is used as a term including change of a position and change of an appearance. The term “appearance” is used as a term including shape, pattern, and color.

In this timing controller, the controlling unit sets speed of the change of the predetermined image to a constant value without depending on the audio signal.

In the timing controller, the predicting unit predicts the occurrence timing of the base point of the cyclic repetition of the audio signal on the basis of a frequency and a phase of the cyclic repetition of the audio signal, and the predetermined time.

For example, the predicting unit comprising: a converting unit operable to convert the audio signal from a time domain to a frequency domain; a frequency detecting unit operable to detect a peak value from the audio signal as converted to the frequency domain to regard a frequency of the peak value as a frequency of the cyclic repetition of the audio signal; a phase detecting unit operable to detect a phase of a peak value of the audio signal with time of a predetermined clock as a criterion to regard the phase of the peak value as a phase of the cyclic repetition of the audio signal; and a unit operable to predict the occurrence timing of the base point of the cyclic repetition of the audio signal on the basis of the frequency and the phase of the cyclic repetition of the audio signal, and the predetermined time.

In the above timing controller, the predicting unit corrects a result of the prediction of the occurrence timing of the base point of the cyclic repetition of the audio signal in accordance with a shift of a phase of the audio signal.

In accordance with this configuration, even if the phase changes in midstream of the serial audio signal (e.g., in midstream of one music), since the prediction result is corrected in accordance with the change, it is possible to prevent the shift of the phase from affecting the prediction result.

In the above timing controller, the predicting unit corrects the currently predicted occurrence timing of the base point of the cyclic repetition to more retarded timing when an absolute value of a difference between the currently predicted occurrence timing of the base point of the cyclic repetition and the previously predicted occurrence timing of the base point of the cyclic repetition is smaller than a value obtained by multiplying a cycle of the cyclic repetition by a first predetermined number, and/or corrects the currently predicted occurrence timing of the base point of the cyclic repetition to earlier timing when the absolute value of the difference is larger than a value obtained by multiplying said cycle by a second predetermined number, and wherein the first predetermined number is larger than 0 and smaller than 1 while the second predetermined number is larger than 1 and smaller than 2.

In accordance with this configuration, in the case where the difference between the currently predicted occurrence timing of the base point of the cyclic repetition and the previously predicted occurrence timing of the base point of the cyclic repetition is extremely smaller or larger than the cycle of the cyclic repetition, the occurrence timing can be corrected appropriately.

In this timing controller, the first predetermined number is 0.5 while the second predetermined number is 1.5, and wherein the predicting unit corrects the currently predicted occurrence timing of the base point of the cyclic repetition to more retarded timing by a time period equal to said cycle when the absolute value of the difference is smaller than the value obtained by multiplying said cycle by the first predetermined number, and/or corrects the currently predicted occurrence timing of the base point of the cyclic repetition to earlier timing by a time period equal to said cycle when the absolute value of the difference is larger than the value obtained by multiplying said cycle by the second predetermined number.

In accordance with this configuration, when the currently predicted occurrence timing of the base point of the cyclic repetition is closer to the timing when the predetermined result is effected based on the previous prediction than the timing at which the predetermined result should be essentially effected based on the current prediction, or when the currently predicted occurrence timing of the base point of the cyclic repetition is closer to the timing when the predetermined result is effected based on the next prediction than the timing at which the predetermined result should be essentially effected based on the current prediction, the currently predicted occurrence timing of the base point of the cyclic repetition can be conformed to or brought close to the timing at which the predetermined result should be essentially effected based on the current prediction.

In the above timing controller, the setting unit sets the event so that a time from time when the event is set until a time when the predetermined result is effected coincides with a cycle of the cyclic repetition of the audio signal.

In accordance with this configuration, the activation time (the time from the time when the control is started until the time when the predetermined result is effected) differs depending on the speed (tempo) of the cyclic repetition of the audio signal. Thus, when the cyclic repetition of the audio signal differs, the control within the activation time also differs, and thereby it is possible to give the different expression and effect depending on the audio signal.

For example, in the case where the audio signal is music, the activation time depends on the tempo of the music. Thus, when the tempo of the music differs, the control within the activation time also differs, and thereby it is possible to give the different expression and effect for each music piece.

In this timing controller, the predetermined control is control of a predetermined image, and wherein the controlling unit starts change of the predetermined image in response to the set event to allow the predetermined image to effect the predetermined result at the occurrence timing as predicted.

In accordance with this configuration, the activation time differs depending on the speed (tempo) of the cyclic repetition of the audio signal. Thus, when the cyclic repetition of the audio signal differs, the control of the predetermined image within the activation time also differs, and thereby it is possible to give the different expression and effect by the predetermined image depending on the audio signal.

For example, in the case where the audio signal is music, the activation time depends on the tempo of the music. Thus, when the tempo of the music differs, the control of the predetermined image within the activation time also differs, and thereby it is possible to give the different expression and effect by the predetermined image for each music piece.

Incidentally, the term “change” is used as a term including change of a position and change of an appearance. The term “appearance” is used as a term including shape, pattern, and color.

In the above timing controller, the predicting unit comprises a detecting unit operable to detect the cyclic repetition of the audio signal on the basis of amplitude of the audio signal.

In accordance with this configuration, since the cyclic repetition of the audio signal is detected based on the amplitude of the audio signal, it is possible to reduce the processing load in comparison with the detection by the frequency analysis and furthermore reduce software and/or hardware.

In this timing controller, the detecting unit detects a time from a base point to a base point of the cyclic repetition of the audio signal on the basis of the amplitude of the audio signal, and determines a cycle of the cyclic repetition on the basis of an occurrence frequency of said time as detected.

In accordance with this configuration, the cycle of the audio signal is determined based on the occurrence frequency of the time from the base point to the base point of the cyclic repetition of the audio signal, i.e., the statistical result. Thus, it is possible to determine the highly reliable and stable cycle.

In this timing controller, the detecting unit corrects the currently predicted occurrence timing of the base point of the cyclic repetition on the basis of amplitude of the audio signal near the previously predicted base point of the cyclic repetition.

In accordance with this configuration, the deviation (error) between the previously predicted occurrence timing of the base point of the cyclic repetition and the actual occurrence timing of the base point of the cyclic repetition of the audio signal is corrected by the currently prediction, and thereby it is possible to reduce the accumulation of the deviation as much as possible.

In this timing controller, the detecting unit corrects the currently predicted occurrence timing of the base point of the cyclic repetition by using, as a base point, time when maximum amplitude of the audio signal within a predetermined range including the previously predicted base point of the cyclic repetition arises.

In the above timing controller, the audio signal is input from an external recording medium recording the audio signal or a communication line.

Also, in the above timing controller, the audio signal is input from a microphone which converts an audio signal into an electrical signal.

In the above timing controller, a plurality of the predetermined images is displayed.

In accordance with this configuration, it is possible to conform a time when the predetermined result is effected to the base point of the cyclic repetition regardless of the length of the cycle of the cyclic repetition of the audio signal. For example, it is assumed that one predetermined image is commonly displayed for all events. When the cycle of the cyclic repetition is too short, a time from one event to the next event is also short. If it does, before effecting the predetermined result corresponding to one event, the next event may be set. That is, before the predetermined image effects the predetermined result in response to one event, the predetermined image has to been started to be controlled in response to the event as set next. As the result, it is not possible to effect the predetermined result at the base point of the cyclic repetition.

In the above timing controller, the predetermined image is prepared anew for each event which is sequentially set on the basis of a result of the prediction.

In accordance with this configuration, it is possible to conform a time when the predetermined result is effected to the base point of the cyclic repetition regardless of the length of the cycle of the cyclic repetition of the audio signal. For example, it is assumed that one predetermined image is commonly used for all events. When the cycle of the cyclic repetition is too short, a time from one event to the next event is also short. If it does, before effecting the predetermined result corresponding to one event, the next event may be set. That is, before the predetermined image effects the predetermined result in response to one event, the predetermined image has to been started to be controlled in response to the event as set next. As the result, it is not possible to effect the predetermined result at the base point of the cyclic repetition.

In accordance with a second aspect of the present invention, a timing controlling method, comprising the steps of: detecting cyclic repetition of an audio signal by analyzing the audio signal as input from outside to predict occurrence timing of a base point of the cyclic repetition; setting an event on the basis of the occurrence timing as predicted; and performing a predetermined control in response to the set event to effect a predetermined result at the occurrence timing as predicted. In accordance with this configuration, the same advantage as the above first aspect of the timing controller can be gotten.

In accordance with a third aspect of the present invention, a timing controlling program is a computer program for executing the above second aspect of the timing controlling method. The advantage thereof is the same as that of the first aspect of the timing controller.

In accordance with a fourth aspect of the present invention, a recording medium is a computer readable recording medium storing the above third aspect of the timing controlling program. The advantage thereof is the same as that of the first aspect of the timing controller.

The recording medium includes, for example, a flexible disk, a hard disk, a magnetic tape, a magneto-optical disk, a CD (including CD-ROM, Video-CD), a DVD (including DVD-Video, DVD-ROM, DVD-RAM), a ROM cartridge, a RAM memory cartridge with a battery backup unit, a flash memory cartridge, a nonvolatile RAM cartridge.

### BRIEF DESCRIPTION OF DRAWINGS

The novel features of the present invention are set forth in the appended any one of claims. The invention itself, however, as well as other features and advantages thereof, will be best understood by reference to the detailed description of specific embodiments which follows, when read in conjunction with the accompanying drawings, wherein:

FIG. 1 is a view showing an example of a screen displayed by an audio visual system in accordance with a first embodiment of the present invention.

FIG. 2 is a schematic diagram for showing the electric configuration of the audio visual system in accordance with the first embodiment of the present invention.

FIG. 3 is a circuit diagram for showing an audio circuit 5 of FIG. 2.

FIG. 4 is an explanatory view of a method for determining set timing of an event EVn.

FIG. 5 is an explanatory view of a method for determining set timing of a next event EVn+1 when the event EVn is set earlier.

FIG. 6 is an explanatory view of a method for determining set timing of a next event EVn+1 when the event EVn is set more retarded.

FIG. 7 is an explanatory view of correction processing of an event set time X.

FIG. 8 is a flow chart showing an overall process flow of a processor 3 of FIG. 2.

FIG. 9 is a flow chart showing a process for acquiring a cycle B of a beat of music in step S3 of FIG. 8.

FIG. 10 is a flow chart showing a process for counting time t_{F} in step S5 of FIG. 8.

FIG. 11 is a flow chart showing a process for detecting a phase P of the beat of the music in step S7 of FIG. 8.

FIG. 12 is a flow chart showing a process for calculating the event set time X in step S11 of FIG. 8.

FIG. 13 is a flow chart showing a process for setting the event EVn in step S13 of FIG. 8.

FIG. 14 is a flow chart showing a process for calculating a frequency spectrum in step S31 of FIG. 9.

FIG. 15 is a flow chart showing a process for controlling animation in step S12 of FIG. 8.

FIG. 16 is a schematic diagram for showing the electric configuration of the audio visual system in accordance with a second embodiment of the present invention.

FIG. 17(a) is a wave form chart for showing an audio signal ALR to be input to an MCU 35 of FIG. 16. FIG. 17(b) is a wave form chart for showing a differential audio signal Df as obtained from the wave of FIG. 17(a).

FIG. 18(a) is a view showing an example of an occurrence frequency table. FIG. 18(b) is a view showing distribution of an occurrence frequency of an external beat interval Tv.

FIG. 19 is a detail-explanatory view showing a method for generating an internal beat.

FIG. 20 is a flow chart showing a process for acquiring audio data by the MCU 35 of FIG. 16.

FIG. 21 is a flow chart showing a process for detecting an external beat by the MCU 35 of FIG. 16.

FIG. 22 is a flow chart showing a process for generating the internal beat by the MCU 35 of FIG. 16.

FIG. 23 is a flow chart showing a process of a processor 3 of FIG. 16.

FIG. 24 is a flow chart showing a process of step 5502 of FIG. 23.

FIG. 25 is a flow chart showing a process of step 5504 of FIG. 23.

### EXPLANATION OF REFERENCES

1, 2 . . . audio visual apparatus, 3 . . . processor, 5 . . . audio circuit, 7 . . . external memory, 9 . . . digital audio player, 11 . . . television monitor, and 35 . . . MCU.

### BEST MODE FOR CARRYING OUT THE INVENTION

In what follows, several embodiments of the present invention will be explained in detail with reference to the accompanying drawings. Meanwhile, like references indicate the same or functionally similar elements throughout the respective drawings, and therefore redundant explanation is not repeated. Also, a symbol “*” represents multiplication in the present specification and figures.

### First Embodiment

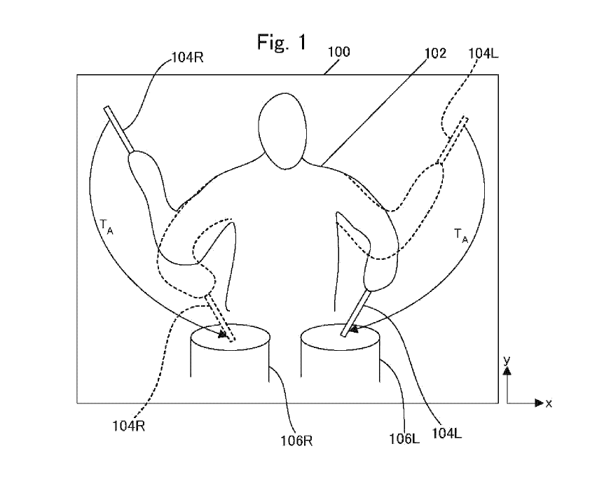

FIG. 1 is a view showing an example of a screen 100 displayed by an audio visual system in accordance with the first embodiment of the present invention. Referring to FIG. 1, the screen 100 displayed by this audio visual system contains a character 102 which represents a person, a stick 104L which is grasped with a left hand of the character 102, a stick 104R which is grasped with a right hand of the character 102, a drum object 106L which represents a drum, and a drum object 106R which represents a drum. Incidentally, the sticks 104L and 104R are comprehensively referred to as sticks 104, and the drum objects 106L and 106R are comprehensively referred to as drum objects 106. Also, in this screen, a horizontal axis is regarded as x axis, a vertical axis is regarded as y axis, and a center of the screen is regarded as an origin.

This audio visual system displays animation in which the character 102 strikes alternately the drum objects 106L and 106R with the stick 104L and 104R respectively. In this case, the audio visual system performs frequency analysis of audio signals AL_{E}, AR_{E} as input from outside, and displays the animation in which the drum objects 106L and 106R are struck with the sticks 104L and 104R along to a beat (or rhythm) of music represented by the audio signals AL_{E}, AR_{E}.

Incidentally, in the present specification, a beat and rhythm are used as a term for representing cyclic repetition of an audio signal. A beat may be called a meter generally. Also, a beat is used also as a term for representing a base point of cyclic repetition of an audio signal. The base point of the cyclic repetition of the audio signal means a starting point of one cycle of the audio signal, and the base point of one cycle coincides with an ending point of a previous one cycle.

Specifically, in the present embodiment, the animation is controlled so that timing at which the stick 104 reaches the drum object 106 coincides with the beat of music. Accordingly, a time from time when the stick 104L reaches the drum object 106L until time when the stick 104R reaches the drum object 106R coincides with a cycle of the beat of the music. Because the drum objects 106L and 106R are alternately struck.

Incidentally, a time until the stick 104 reaches the drum object 106 by swinging the stick 104 down from a state in which the character 102 swings the stick 104 up is a certain time T_{A}. Accordingly, if a motion for swinging the stick 104 down is started at time when the beat of the music occurs, timing at which the stick 104 reaches the drum object 106 does not coincide with the beat of the music. Thus, it needs to start swinging the stick 104 down the time T_{A} prior to the beat of the music. In the present embodiment, setting of timing for starting to swing the stick 104 down is called setting of the event EVn, and the frequency analysis of the audio signals AL_{E} and AR_{E} is performed so as to appropriately set the event EVn.

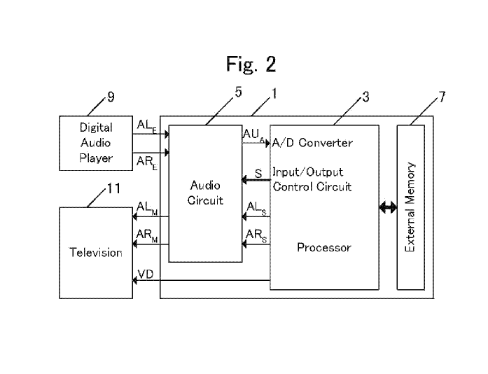

FIG. 2 is a schematic diagram for showing the electric configuration of the audio visual system in accordance with the first embodiment of the present invention. Referring to FIG. 2, this audio visual system is provided with an audio visual apparatus 1 and a television monitor 11 coupled therewith. The audio visual apparatus 1 includes a processor 3, an external memory 7, and an audio circuit 5.

The processor 3 is coupled with the external memory 7. The external memory 7, for example, is provided with a flash memory, a ROM, and/or a RAM. The external memory 7 includes a program area, an image data area, and an audio data area. The program area stores control programs for making the processor 3 execute various processes as shown in flowcharts as described below. The image data area stores all of image data which constitutes screens to be displayed on the television monitor 11, and other necessary image data. The audio data area stores audio data for sound effect and so on. The master processor 3 executes the control programs in the program area, reads the image data in the image data area and the audio data in the audio data area, performs necessary processes, and generates a video signal VD and audio signals ALs and ARs. The video signal VD is supplied to the television monitor 11 through an AV cable.

The audio signals ALs and ARs generated by the processor 3, and the audio signals AL_{E}, AR_{E} input from a digital audio player 9 are given to the audio circuit 5, are mixed, and are output to a speaker of the television monitor 11 as audio signals AL_{M} and AR_{M}. Also, the audio signals AL_{E}, AR_{E} input from a digital audio player 9 are mixed, and are input to an A/D converter of the processor 3 as an audio signal AU_{A}. The processor 3 analyzes a frequency of the audio signal AU_{A}. Also, the processor gives a control signal S of the audio circuit 5 to the audio circuit 5.

Although not shown in the figure, the processor 3 includes various functional blocks such as a CPU (central processing unit), a graphics processor, a sound processor, and a DMA controller, and in addition to this, includes an A/D converter for receiving analog signals, an input/output control circuit for receiving input digital signals such as key manipulation signals and infrared signals and giving the output digital signals to external devices, an internal memory, and so on.

The CPU executes the control programs stored in the external memory 7. The CPU receives the digital signals from the A/D converter and the digital signals from the input/output control circuit, and then executes necessary operations based on these signals in accordance with the control programs. The graphics processor performs graphics processing, which the result of the operation of the CPU requires, to the image data stored in the external memory 7 to generate the video signal VD representing images to be displayed on the television monitor 11. The sound processor performs sound processing, which the result of the operation of the CPU requires, to the audio data stored in the external memory 7 to generate the audio signals ALs and ARs representing sound effect and so on. The internal memory is, for example, a RAM, and is used as a working area, a counter area, a register area, a temporary data area, a flag area and/or the like area.

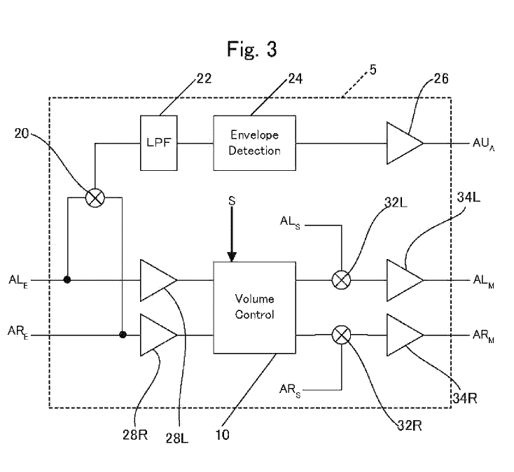

FIG. 3 is a circuit diagram for showing the audio circuit 5 of FIG. 2. Referring to FIG. 3, this audio circuit 5 includes a mixing circuit 20, lowpass filter (LPF) 22, an envelope detection circuit 24, an amplifier 26, amplifiers 28L and 28R, a volume control circuit 10, mixing circuits 32L and 32R, and amplifiers 34L and 34R.

The analog audio signals AL_{E} and AR_{E} input from the digital audio player 9 are mixed by the mixing circuit 20, then it is given to the lowpass filter 22, and further then low frequency components (e.g., 100 Hz or less) thereof are given to the envelope detection circuit 24. The envelope detection circuit 24 performs the envelope detection of the low frequency components as input to output to the amplifier 26. The amplifier 26 amplifies the signal as output from the envelope detection circuit 24 to give the processor 3 as the audio signal AU_{A}.

On the other hand, the amplifiers 28L and 28R respectively amplify the analog audio signals AL_{E} and AR_{E} as input from the digital audio player 9 to give the volume control circuit 10. The volume control circuit 10 controls volumes of the analog audio signals AL_{E} and AR_{E} as input in accordance with the control signal S of the processor 3, and gives them to the mixing circuits 32L and 32R respectively. The mixing circuit 32L mixes the analog audio signal ALs generated by the processor 3 and the volume-controlled audio signal AL_{E} to output to the amplifier 34L. The amplifier 34L amplifies the audio signal as input to output as the audio signal AL_{M}. The mixing circuit 32R mixes the analog audio signal ARs generated by the processor 3 and the volume-controlled audio signal AR_{E} to output to the amplifier 34R. The amplifier 34R amplifies the audio signal as input to output as the audio signal AR_{M}.

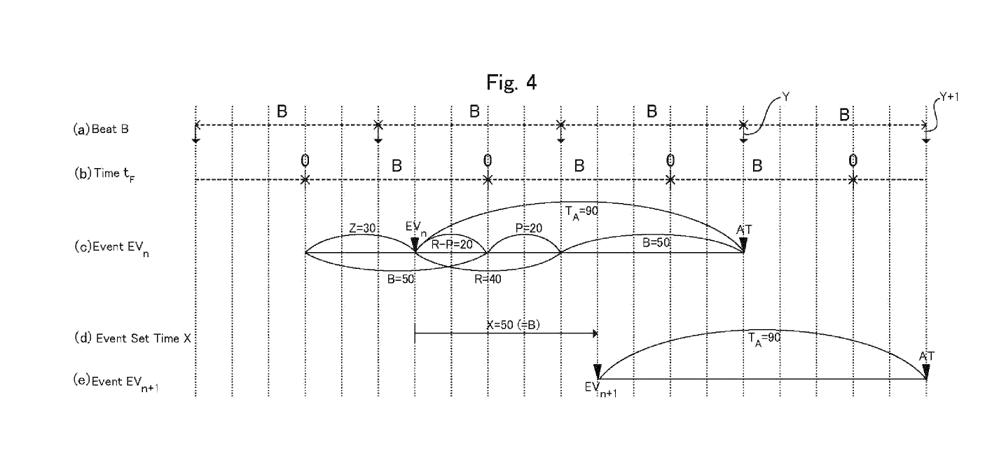

Next, the method for determining the set timing of the event EVn will described referring to the figures. Incidentally, in the examples of FIGS. 4 to 7, it is assumed that the reaching time T_{A} is 90 video frames. Although described below, a television screen is updated in synchronization with an interruption based on a video system synchronous signal. In this case, this interruption is generated at every certain time. The one certain time is called one video frame. In the present embodiment, for example, it is assumed that one video frame is 1/60 second.

FIG. 4 is an explanatory view of a method for determining the set timing of the event EVn. As shown in FIG. 4(a), the processor 3 analyzes the frequency of the audio signal AU_{A} coming from the digital audio player 9 to obtain a cycle B of the beat of the music represented by the audio signal AU_{A} In the examples of FIGS. 4 to 7, it is assumed that the cycle B is 50 video frames. It is assumed that an interval between broken lines is 10 video frames in the figures.

As shown in FIG. 4(b), the processor 3 has a clock t_{F} which starts from time 0, counts until time (B-1), and then returns time 0 again.

As shown in FIG. 4(c), it is assumed that the processor 3 sets the n-th event EVn (a black inverted triangle EVn) after the elapse of Z (=30) video frames from the time t_{F}=0. The setting of the event EVn corresponds to timing for starting to swing the stick 104 down by the character 102. Accordingly, the processor 3 starts the animation of swinging the stick 104 down at time when the event EVn is set. Then, the stick 104 reaches the drum object 106 after the elapse of the time T_{A} (=90 video frames) from the setting of the event EVn (a black inverted triangle AT). The event EVn is an event which coincides with the Y-th beat Y of the music.

As shown in FIGS. 4(d) and 4(e), the processor 3 sets the (n+1)-th event EVn+1 after the elapse of X video frames from the setting time of the event EVn. In this case, X=B=50. Because the cycle of the beat of the music is the cycle B. The processor 3 starts the animation of swinging the stick 104 down at time when the event EVn+1 is set. Then, the stick 104 reaches the drum object 106 after the elapse of the time T_{A} (=90 video frames) from the setting of the event EVn+1 (a black inverted triangle AT). The event EVn+1 is an event which coincides with the (Y+1)-th beat Y+1 of the music.

By the way, as is obvious from the FIG. 4, a time Z from base time 0 until the setting of the event EVn is represented by the following formula.

Z=B−(R−P) (1)

The term P indicates a deviation of the beat of the music from the base time 0 of the clock t_{F}, i.e., a phase of the beat of the music from the base time 0 of the clock t_{F}. The term R represents a remainder obtained by dividing the reaching time T_{A} by the cycle B.

The reaching time T_{A} of the stick 104 is constant, and therefore it is possible to predict occurrence timing of the beat of the music by obtaining the cycle B and the phase P of the beat of the music. Accordingly, it is possible to set the event EVn so as to coincide with the predicted beat of the music, i.e., the future beat of the music.

By the way, in the example of the FIG. 4(c), the event EVn is set with the appropriate timing. However, an error E may occur in the set timing of the event EVn. In this case, the set timing of the next event EVn+1 has to been adjusted. If it is not adjusted, the error E is accumulated, and thereby timing in which the stick 104 reaches the drum object 106 deviates from the beat of the music. Therefore, the following adjustment is performed.

First, adjustment in the case where the event EVn is set earlier will be described. Such case occurs when the phase P of the beat of the music varies to become large. In what follows, the example, in which the phase P varies from 20 video frames (the case of FIGS. 4) to 30 video frames, is cited.

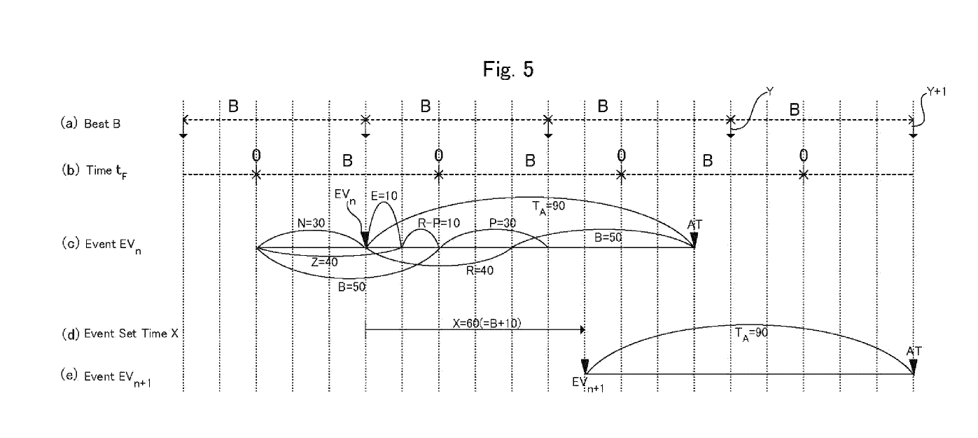

FIG. 5 is an explanatory view of a method for determining set timing of the next event EVn+1 when the event EVn is set earlier. As shown in FIG. 5(c), it is assumed that the processor 3 sets the n-th event EVn after the elapse of N (=30) video frames from the time t_{F}=0 (a black inverted triangle EVn). Although the n-the event EVn has to been set after the elapse of Z video frames (=40) from the time t_{F}=0 because the phase P varies to become large, the event EVn is set earlier by 10 video frames. That is, the error E in the setting is the positive 10 video frames.

As is obvious from the FIG. 5(c), even the case where the event EVn is set earlier, the above formula (1) and the following formula are true.

E=Z−N=B−(R−P)−N=B−R+P−N (2)

The term N represents an actual time from the base time 0 of the clock t_{F} until the setting of the event EVn. The term Z is a correct time from the base time 0 of the clock t_{F} until the setting of the event EVn.

In the case where the event EVn is set earlier, if the next event EVn+1 is set after the elapse of X (=B=50) video frames from the set time of the event EVn, naturally, the event EVn+1 is also set earlier. Accordingly, it needs to retard the set time of the event EVn+1. In this case, in the above example, since the event EVn is set earlier by the error E (=10), the next event EVn+1 is set more retarded by the error E (=10). That is, in the case where the event EVn is set earlier, an event emergence time X is represented by the following formula.

X=B+E (3)

Incidentally, in the example of FIG. 4, Z=N, and therefore E=0. That is, the set time of the event EVn is correct. Accordingly, the event emergence time X is represented by the following formula.

X=B (4)

Next, adjustment in the case where the event EVn is set more retarded will be described. Such case occurs when the phase P of the beat of the music varies to become small. In what follows, the example, in which the phase P varies from 20 video frames (the case of FIGS. 4) to 10 video frames, is cited.

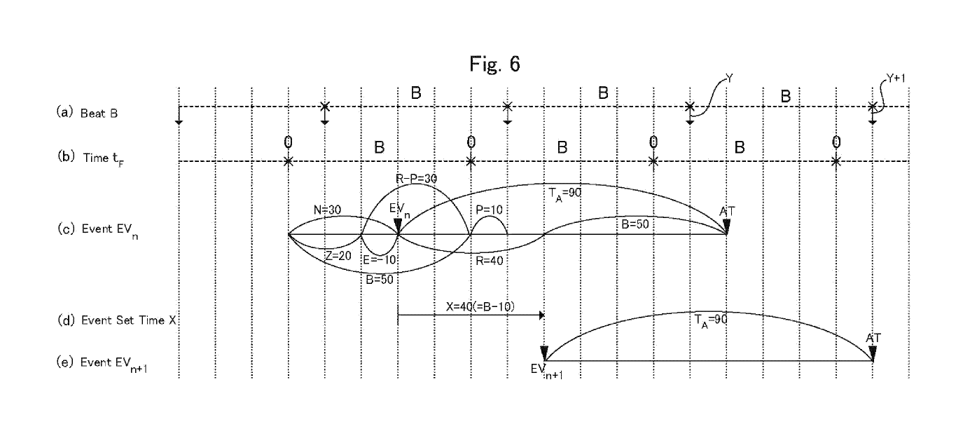

FIG. 6 is an explanatory view of a method for determining set timing of the next event EVn+1 when the event EVn is set more retarded. As shown in FIG. 6(c), it is assumed that the processor 3 sets the n-th event EVn after the elapse of N (=30) video frames from the time t_{F}=0 (a black inverted triangle EVn). Although the n-the event EVn has to been set after the elapse of Z video frames (=20) from the time t_{F}=0 because the phase P varies to become small, the event EVn is set more retarded by 10 video frames. That is, the error E in the setting is the negative 10 video frames.

As is obvious from the FIG. 6(c), even the case where the event EVn is set more retarded, the above formulae (1) and (2) are true.

In the case where the event EVn is set more retarded, if the next event EVn+1 is set after the elapse of X (=B=50) video frames from the set time of the event EVn, naturally, the event EVn+1 is also set more retarded. Accordingly, it needs to expedite the set time of the event EVn+1. In this case, in the above example, since the event EVn is set more retarded by the error E (=−10), the next event EVn+1 is set earlier by the error E (=−10). In this case, the event set time X is represented by the formula (3). Incidentally, a sign of the error E is negative if the event EVn is set more retarded, conversely a sign of the error E is positive if the event EVn is set earlier.

By the way, in the case where the event set time X is inappropriately set long or short, a case where the stick is not swung so as to coincide with the beat occurs. Thus, in the present embodiment, the event set time X is corrected as follows.

[1] Case: (½)*B<X<(3/2)*B (5)

In this case, the event set time X is set without correcting.

[2] Case: X≦(½)*B (6)

X<−X+B (7)

The correction is reiterated on the basis of the formula (7) until the X corrected by the formula (7) satisfies the formula (5), and the corrected X which satisfies the formula (5) is set as the final event set time.

[3] Case: (3/2)*B≦X (8)

X<−X−B (9)

The correction is reiterated on the basis of the formula (9) until the X corrected by the formula (9) satisfies the formula (5), and the corrected X which satisfies the formula (5) is set as the final event set time.

Next, the correction process based on the formulae (5) to (9) will be described referring to figures.

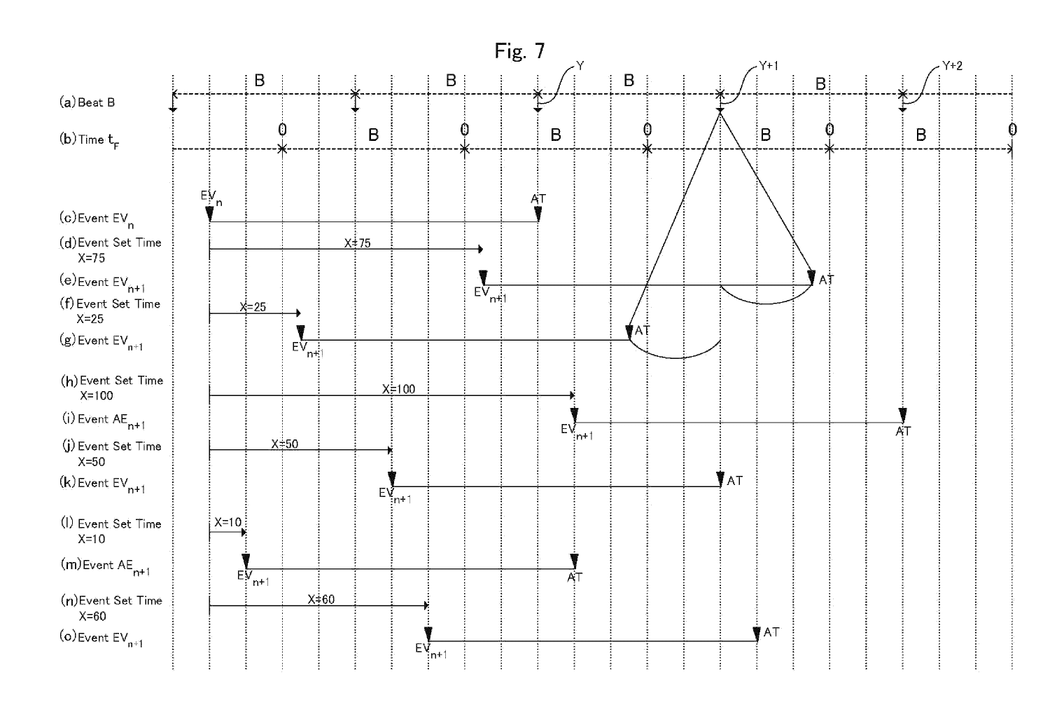

FIG. 7 is an explanatory view of the correction processing of the event set time X. As shown in FIGS. 7(c) and 7(d), it is assumed that the event set time X (=(3/2)*50=75) is set at the time when the event EVn is set. And, as shown in FIG. 7(e), the event EVn+1 is set after the elapse of 75 video frames from the time when the event EVn is set. The event EVn is conformed to a future beat Y while the event EVn+1 is conformed to a future beat Y+1. However, the reaching time T_{A} (a black inverted triangle AT) based on the event EVn+1 of FIG. 7(e) is later relative to the beat Y+1 by 25 video frames.

On the other hand, as shown in FIGS. 7(c) and 7(f), it is assumed that the event set time X (=(½)*50=25) is set at the time when the event EVn is set. And, as shown in FIG. 7(g), the event EVn+1 is set after the elapse of 25 video frames from the time when the event EVn is set. However, the reaching time T_{A} (a black inverted triangle AT) based on the event EVn+1 of FIG. 7(g) is earlier relative to the beat Y+1 by 25 video frames.

That is, if the X satisfies the formula (5), the error falls within ±25 video frames relative to the future beat to be conformed. In this case, the reaching time T_{A} is closer to the occurrence time of the beat Y+1 to be conformed than the previous beat Y and the next beat Y+2. Thus, if the X satisfies the formula (5), it can be considered that the event set time X is an event which is conformed to the beat Y+1. However, if the X does not satisfy the condition of the formula (5) and exists within the range of the formula (8), substantially, it can not be considered that the event set time X is conformed to the beat Y+1. For example, as shown in FIG. 7(h), it is assumed that the event set time X is set to 100. And, as shown in FIG. 7(i), the event EVn+1 is set after the elapse of 100 video frames from the time when the event EVn is set. In this case, the reaching time T_{A} based on the event EVn+1 of FIG. 7(i) is later relative to the beat Y+1 by 50 video frames. Under such circumstances, the reality is to consider that the event EVn+1 is conformed to the beat Y+2. Therefore, as shown in FIGS. 7(j) and 7(k), the X is corrected by the formula (9) to set the event EVn+1.

On the other hand, when the X does not satisfy the condition of the formula (5) and exists within the range of the formula (6), similarly, substantially it can not be considered that the event set time X is conformed to the beat Y+1. For example, as shown in FIG. 7(l), it is assumed that the event set time X is set to 10. And, as shown in FIG. 7(m), the event EVn+1 is set after the elapse of 10 video frames from the time when the event EVn is set. In this case, the reaching time T_{A} based on the event EVn+1 of FIG. 7(m) is earlier relative to the beat Y+1 by 40 video frames. Under such circumstances, the reality is to consider that the event EVn+1 is conformed to the beat Y. Therefore, as shown in FIGS. 7(n) and 7(o), the correction is performed by the formula (7) to set the event EVn+1.

Next, the process flow of the processor 3 will be described using flowcharts.

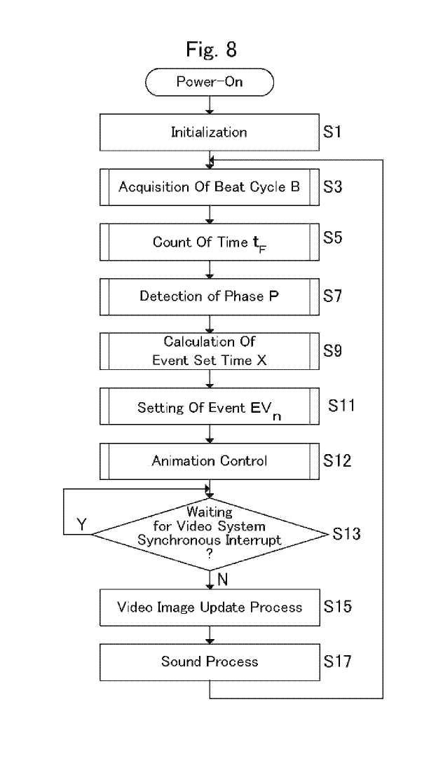

FIG. 8 is a flow chart showing an overall process flow of the processor 3 of FIG. 2. Referring to FIG. 8, in step S1, the processor 3 performs the initial settings of the system. In this step S1, variables, counters, timers, flags, and the clock t_{F} are initialized.

In step S3, the processor 3 performs the process for acquiring the cycle B of the beat of the music from the digital audio player 9. In step S5, the processor 3 performs the process for counting the time t_{F}, i.e., the time counting processing of the clock t_{F}. In step S7, the processor 3 performs the process for detecting the phase P of the beat of the music from the digital audio player 9. In step S9, the processor 3 calculates the event set time X. In step S11, the processor 3 sets the event EVn. In step S12, the processor 3 controls the animation in which the character 102 swings the stick 104 in accordance with the setting of the event EVn in step S11.

In step S13, the processor 3 determines whether or not the interrupt based on the video system synchronous signal is waited for, the processor 3 returns to step S13 if the state is a state of waiting for the interrupt, conversely, if the state is not the state of waiting for the interrupt, i.e., if the interrupt based the video system synchronous signal is given, in step S15, the processor 3 updates the images to be displayed on the television monitor 11 on the basis of the results of the processes of steps S3 to S12 while the processor 3 performs the sound processing with regard to the sound effect and so on in step S17, and then the processor 3 proceeds to step S3.

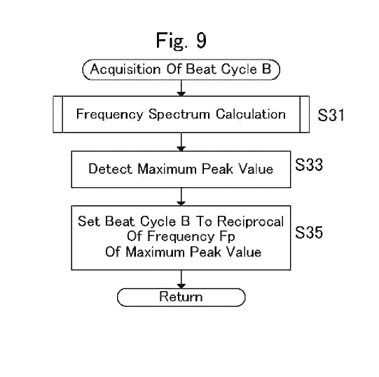

FIG. 9 is a flow chart showing the process for acquiring the cycle B of a beat of music in step S3 of FIG. 8. Referring to FIG. 9, in step S31, the processor 3 applies Fourier transformation on the audio signal AU_{A} from the digital audio player 9 (the audio circuit 5) so as to convert from a time domain to a frequency domain, and thereby obtains a frequency spectrum. In step S33, the processor 3 detects a maximum peak value (a maximum crest value) of the frequency spectrum. In step S35, the processor 3 sets the cycle B of the beat of the music to a reciprocal of the frequency Fp of the maximum peak value.

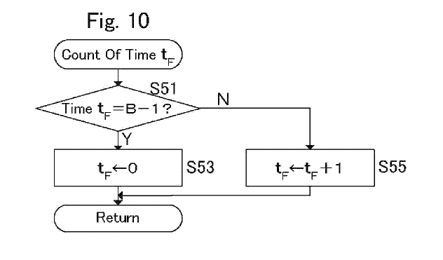

FIG. 10 is a flow chart showing a process for counting the time t_{F} in step S5 of FIG. 8. Referring to FIG. 10, in step S51, the processor 3 determines whether or not the clock t_{F} coincides with B-1, the process proceeds to step S53 so as to set the clock to 0 if it coincides, conversely the process proceeds to step S55 if it does not coincide. The B indicates the cycle of the beat. Instep S53, the processor 3 sets the clock t_{F} to 0, and then returns. On the other hand, in step S55, the processor 3 increases the clock t_{F} by one, and then returns.

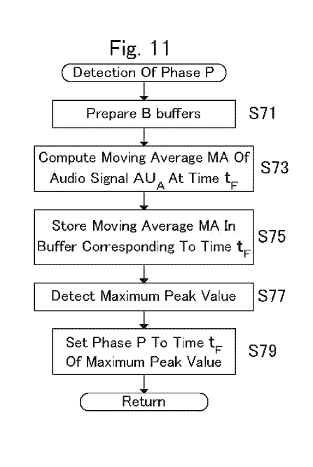

FIG. 11 is a flow chart showing a process for detecting the phase P of the beat of the music in step S7 of FIG. 8. Referring to FIG. 11, in step S71, the processor 3 prepares the number of buffers equal to the value of the cycle B of the beat of the music in the internal memory. Incidentally, a unit of the cycle B is a video frame, and therefore the cycle B is obtained as a natural number (step S3). In step S73, the processor 3 calculates a moving average MA of the audio signal AU_{A} at the time t_{F}. In step S75, the processor 3 stores the moving average MA in the buffer corresponding to the time t_{F}. In step S77, the processor 3 detects the maximum peak value from the moving averages MA stored in the buffers. In step S79, the processor 3 sets the phase P to the time t_{F} of the maximum peak value, and then returns.

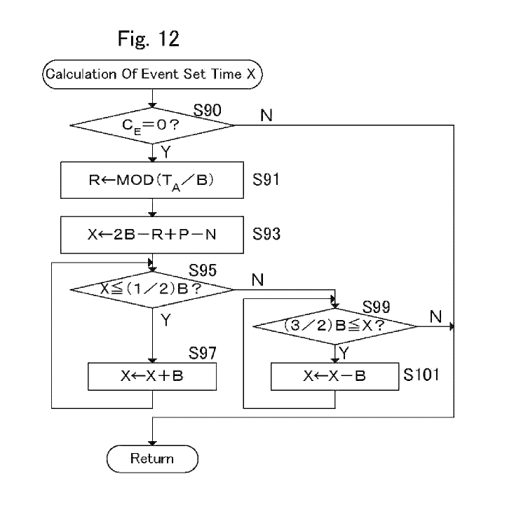

FIG. 12 is a flow chart showing a process for calculating the event set time X in step S11 of FIG. 8. Referring to FIG. 12, in step S90, the processor 3 determines whether or not a counter C_{E} which performs a countdown operation from the event set time X is 0, the process proceeds to step S91 if it is 0, conversely the process returns if it is not 0. In step S91, the processor 3 obtains the remainder (fraction) R obtained by dividing the reaching time T_{A} (see FIG. 1) by the cycle B. In step S93, the processor 3 obtains the event set time X on the basis of the formula (3).

In step S95, the processor 3 determines whether or not the X satisfies the formula (6), the process proceeds to step S99 if it does not satisfy, conversely the process proceeds to step S97 if it satisfies. In step S97, the processor 3 corrects the X by the formula (7), and then returns to step S95. In step S99, the processor 3 determines whether or not the X satisfies the formula (8), if it does not satisfy, since the fact means that the formula (5) is satisfied, the process returns without correcting the X, conversely the process proceeds to step S101 if it satisfies. In step S101, the processor 3 corrects the X by the formula (9), and then returns to step S99.

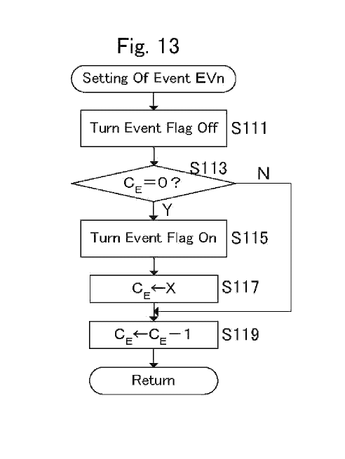

FIG. 13 is a flow chart showing a process for setting the event EVn in step S13 of FIG. 8. Referring to FIG. 13, in step S111, the processor 3 turns an event flag off. The event flag as turned off indicates that the event EVn is not set. In step S113, the processor 3 determines whether or not the counter C_{E} is 0, the process proceeds to step S119 if it is not 0, conversely the process proceeds to step S115 if it is 0. In step S115, the processor 3 turns the event flag on to set the event EVn. In step S117, the processor 3 assigns the event set time X to the counter C_{E}. In step S119, the processor 3 decreases the counter C_{E} by one, and then returns.

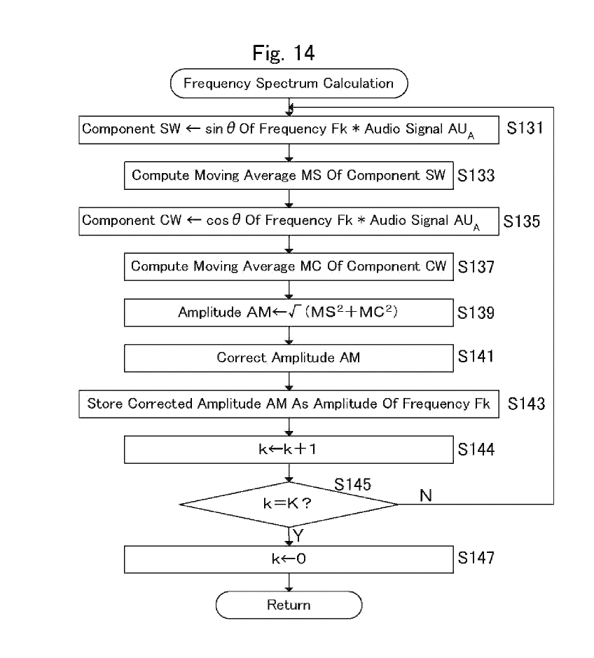

FIG. 14 is a flow chart showing a process for calculating the frequency spectrum in step S31 of FIG. 9. Referring to FIG. 14, in step S131, the processor 3 operates the following formula. A subscript k (=0 to K-1) represents the number of samples.

Sine component SW<−sin θ of Frequency Fk* Audio signal AU_{A} (10)

In step S133, the processor 3 calculates a moving average MS of Sine component SW. In step S135, the processor 3 operates the following formula.

Cosine component CW<−cos θ of Frequency Fk* Audio signal AU_{A} (11)

In step S137, the processor 3 calculates a moving average MC of Cosine component CW. In step S139, the processor 3 operates the following formula to obtain Amplitude AM.

Amplitude AM<−√(MS²+MC²) (12)

In step S141, the processor 3 corrects Amplitude AM. This correction is performed by multiplying Amplitude AM by a coefficient which is defined for each sample frequency Fk. The coefficient is defined so that a coefficient for the lower frequency is relatively larger than that for the higher frequency.

In step S143, the processor 3 stores the corrected amplitude AM as amplitude of the frequency Fk. In step S144, the processor 3 increases the variable (subscript) k by one. In step S145, the processor 3 determines whether or not the variable k is equal to the number K of the samples, the process returns to step S131 if NO, conversely the process proceeds to step S147 if YES. In step S147, the processor 3 assigns 0 to the variable k, and then returns.

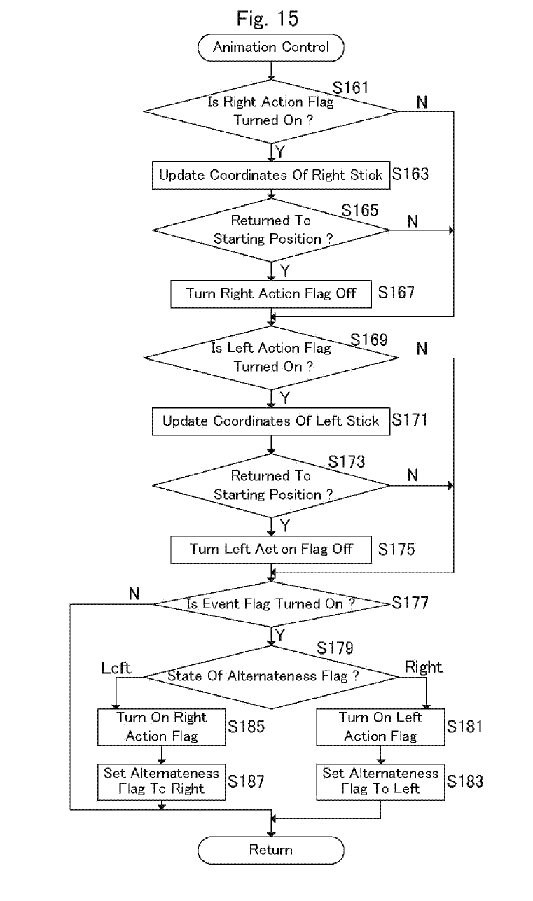

FIG. 15 is a flow chart showing a process for controlling the animation in step S12 of FIG. 8. Referring to FIG. 15, in step S161, the processor 3 checks whether or not a right action flag which is turned on during the operation of the right stick 104R is turned on, the process proceeds to step S163 if it is turned on, conversely the process proceeds to step S169 if it is turned off. In step S163, the processor 3 updates coordinates of the stick 104R. Incidentally, image information (image data and coordinates) is prepared in advance. By the image information, the stick 104R is swung down, strikes the drum object 106R, and is returned to the starting position again. Because the reaching time T_{A}, and the moving distance and the moving velocity of the stick 104R are respectively constant. In step S165, the processor 3 determines whether or not the stick 104R reaches the drum object 106R and returns to the position for starting to swing down again, the process proceeds to step S167 if it returns, conversely the process proceeds to step S169 if it does not return. In step S167, the processor 3 turns the right action flag off.

In step S169, the processor 3 checks whether or not a left action flag which is turned on during the operation of the left stick 104L is turned on, the process proceeds to step S171 if it is turned on, conversely the process proceeds to step S177 if it is turned off. In step S171, the processor 3 updates coordinates of the stick 104L. Incidentally, image information (image data and coordinates) is prepared in advance. By the image information, the stick 104L is swung down, strikes the drum object 106L, and is returned to the starting position again. Because the reaching time T_{A}, and the moving distance and the moving velocity of the stick 104L are respectively constant. In step S173, the processor 3 determines whether or not the stick 104L reaches the drum object 106L and returns to the position for starting to swing down again, the process proceeds to step S175 if it returns, conversely the process proceeds to step S177 if it does not return. In step S175, the processor 3 turns the left action flag off.

In step S177, the processor 3 checks whether or not the event flag is turned on, the process proceeds to step S179 if it is turned on, conversely the process returns if it is turned off. In step S179, the processor 3 checks an alternateness flag, the process proceeds to step S181 if the alternateness flag indicates the right stick 104R, conversely the process proceeds to step S185 if the alternateness flag indicates the left stick 104L. The alternateness flag indicates the stick which starts to move by the previous event flag.

In the case where the alternateness flag indicates the right stick 104R, in step S181, the processor 3 turns the left action flag on so as to start the movement of the left stick 104L. In step S183, the processor 3 sets the alternateness flag to the value for indicating the left flag 104L, and then returns.

On the other hand, in the case where the alternateness flag indicates the left stick 104L, in step S185, the processor 3 turns the right action flag on so as to start the movement of the right stick 104R. In step S187, the processor 3 sets the alternateness flag to the value for indicating the right flag 104R, and then returns.

Besides, in the present embodiment, the reaching time T_{A}, and the moving distance and the moving velocity of the stick 104 are respectively constant, and the timing for stating to swing the stick 104 down is determined in accordance with the beat of the music. These are technique for conforming a time from time when one stick 104 reaches one drum object 106 until time when the other stick 104 reaches the other drum object 106 to the beat of the music. However, in this case, the position for starting to swing the stick 104 down may be fixed outside of the screen. Also, the timing at which the stick 104 appears on the screen may be determined in accordance with the beat of the music. In this case, the reaching time T_{A} is a time from time when the stick 104 appears on the screen until time when the stick 104 reaches the drum object 106.

By the way, as described above, in accordance with the present embodiment, the audio signal AU_{A} such as music is input from outside (in the above example, the digital audio player 9). Thus, the user can enjoy the image together with his/her favorite music, and input the different music to enjoy if the user feels bored.

Also, in the present embodiment, the occurrence timing of the beat of the audio signal AU_{A} is predicted on the basis of the cycle and phase of the external input audio signal AU_{A}, and the reaching time T_{A}, and then the event EVn is set based on the result of the prediction. As the result, it is possible to perform the real-time processing. Therefore, it is possible to be small the scale of the storage means such as a memory, and reduce the cost because a device for playing back the stored audio signal is not required, in comparison with the case where the audio signal is played back and the event is set after storing temporarily and analyzing the audio signal. Incidentally, in the case where the input audio signal is temporarily stored and analyzed, subsequently, the audio signal is played back, and the event is set, a delay occurs because of the storing, analyzing, and playing back, and therefore it is not the real-time processing.

Also, in the present embodiment, the calculation of the event set time X based on the formulae (2) and (3) corresponds to the prediction of the occurrence timing of the beat. Because the expression “the event set time X plus the reaching time T_{A}” represents the occurrence timing of the predicted beat.

Further, since the occurrence timing of the beat of the external input audio signal AU_{A} is predicted, while performing the real-time processing, it is possible to effect the prescribed result, i.e., the strike of the drum object 106 by the stick 104, at the occurrence timing of the future beat of the external input audio signal AU_{A}.

In this way, the strike of the drum object 106 by the stick 104 is conformed to the beat by predicting the occurrence timing of the beat. Accordingly, a time from the strike of the drum object 106 until the strike of the adjacent drum object 106 coincides with the cycle B of the beat. That is, the serial events EVn and EVn+1 are set so that said time coincides with the cycle B of the beat.

Also, in accordance with the present embodiment, the reaching time T_{A} is constant without depending on the speed (tempo) of the beat of the audio signal AU_{A}. As the result, even the beat of the audio signal AU_{A} differs, it is possible to use commonly the animation (i.e., the animation in which the drum object 106 is struck by the stick 104) during the reaching time T_{A} and at the time when the reaching time has elapsed, i.e., process of change of the images (i.e., the animation in which the stick 104 is swung down) and the certain result (i.e., the strike of the drum object 106 by the stick 104), and therefore the constant expression and effect by the animation can be supplied without depending on the beat of the audio signal AU_{A}.

For example, in the case where the audio signal AU_{A} represents the music, the reaching time T_{A} is constant regardless of the tempo of the music. Thus, even the tempo of music differs, it is possible to use commonly the animation during the reaching time T_{A} and at the time when the reaching time has elapsed, and therefore the constant expression and effect by the animation can be supplied without depending on the tempo of music.

Further, in accordance with the present embodiment, the prediction result (corresponding to the event set time X) of the occurrence timing of the beat is corrected in accordance with the change of the phase P of the audio signal AU_{A} (see FIGS. 5 and 6). That is, although it is only necessary to calculate the event set time X by the formula (4) if the phase P does not change and the error E is 0, the event set time X is set to the value obtained by adding the error E to the cycle B based on the formula (3) if the error is not 0.

In this way, since the prediction result of the occurrence timing of the beat is corrected in accordance with the change of the phase P, even if the phase P changes in midstream of the serial audio signal AU_{A} (e.g., in midstream of one music), the prediction result is corrected in accordance with the change, and thereby it is possible to prevent the shift of the phase P from affecting the prediction result.

Still further, in accordance with the present embodiment, when the absolute value of the difference between the currently predicted occurrence timing of the beat and the previously predicted occurrence timing of the beat is smaller than the value obtained by multiplying the cycle B by the first predetermined number (it is more than 0 and less than 1), the currently predicted occurrence timing of the beat is corrected to the more retarded timing (see FIGS. 7(l) to 7(o)).

Also, when the absolute value of the difference between the currently predicted occurrence timing of the beat and the previously predicted occurrence timing of the beat is larger than the value obtained by multiplying the cycle B by the second predetermined number (it is more than 1 and less than 2), the currently predicted occurrence timing of the beat is corrected to the earlier timing (see FIGS. 7(h) to 7(k)).

As the result, in the case where the difference between the currently predicted occurrence timing of the beat and the previously predicted occurrence timing of the beat is extremely smaller or larger than the cycle B, the occurrence timing can be corrected appropriately.

Incidentally, the absolute value of the difference between the currently predicted occurrence timing of the beat and the previously predicted occurrence timing of the beat corresponds to the event set time X. Because the event set time X is a time from the setting of the event EVn until the setting of the next event EVn+1 (see FIG. 4), and the time when the constant reaching time T_{A} elapses from the setting of the event EVn is the predicted occurrence timing of the beat.

More specifically, when the absolute value of the difference between the currently predicted occurrence timing of the beat (the inverted triangle AT of FIG. 7(m)) and the previously predicted occurrence timing of the beat (the inverted triangle AT of FIG. 7(c)) is smaller than the value obtained by multiplying the cycle B by 0.5, i.e., when the currently predicted occurrence timing of the beat is closer to the timing for striking the drum object 104 based on the previous prediction (the beat Y of FIG. 7(a)) than the timing at which the drum object 106 should be essentially struck based on the current prediction (the beat Y+1 of FIG. 7(a)), the currently predicted occurrence timing of the beat is corrected to the more retarded timing by a time period equal to the cycle B based on the formula (7), and thereby the currently predicted occurrence timing of the beat can be conformed to or brought close to the timing at which the drum object 106 should be essentially struck based on the current prediction (see FIGS. 7(l) to 7(o)).

Also, when the absolute value of the difference between the currently predicted occurrence timing of the beat (the inverted triangle AT of FIG. 7(h)) and the previously predicted occurrence timing of the beat (the inverted triangle AT of FIG. 7(c)) is larger than the value obtained by multiplying the cycle B by 1.5, i.e., when the currently predicted occurrence timing of the beat is closer to the timing for striking the drum object 104 based on the next prediction (the beat Y+2 of FIG. 7(a)) than the timing at which the drum object 106 should be essentially struck based on the current prediction (the beat Y+1 of FIG. 7(a)), the currently predicted occurrence timing of the beat is corrected to the earlier timing by a time period equal to the cycle B based on the formula (9), and thereby the currently predicted occurrence timing of the beat can be conformed to or brought close to the timing at which the drum object 106 should be essentially struck based on the current prediction (see FIGS. 7(h) to 7(k)).

### Second Embodiment

Referring to FIG. 1, an audio visual system according to the present embodiment displays animation in which the character 102 strikes alternately the right and left drum objects 106R and 106L with the right and left stick 104R and 104L respectively. In this case, the audio visual system analyzes audio signal ALR as input from outside, and displays the animation in which the drum objects 106 are struck with the sticks 104 along to a beat (or rhythm) of music represented by the audio signal ALR.

In this case, timing at which the stick 104 reaches the drum object 106 is conformed to the beat of the music. Accordingly, a time from time when the stick 104L reaches the drum object 106L until time when the stick 104R reaches the drum object 106R coincides with a cycle of the beat of the music. This point is the same as the first embodiment.

However, in the present embodiment, a time Td until the stick 104 reaches the drum object 106 by swinging the stick 104 down from a state in which the character 102 swings the stick 104 up is conformed to an interval of the beat of the music (an interval between the adjacent beats). Incidentally, in the first embodiment, the reaching time is the constant value T_{A}.

Generally, even the same music, the beat interval of the music is rigorously not constant, and fluctuates. Accordingly, it needs to detect the beat interval each time, and correct the reaching time Td. A couple of examples will be cited with regard to a method for correcting the reaching time Td.

For example, in the case where the moving distance from the position for starting to swing the stick 104 down to the drum object 106 is constant, the moving velocity and/or the acceleration of the stick 104 is corrected based on the beat interval to correct the reaching time Td (the first example). For example, in the case where the moving velocity of the stick 104 is constant, the moving distance from the position for starting to swing down to the drum object 106 (the position for starting to swing the stick 104 down and/or the position of the drum object 106) is corrected based on the beat interval to correct the reaching time Td (the second example). Incidentally, when the beat interval is large, the position for starting to swing the stick 104 down may be outside of the screen. Also, for example, in the case where the position for starting to swing the stick 104 down and the position of the drum 106 are fixed, the trajectory of the stick 104 is corrected based on the beat interval to correct the reaching time Td (the third example). Further, the reaching time Td may be corrected based on the beat interval by combining these examples optionally. Incidentally, in these examples, the position for starting to swing the stick 104 down may be outside of the screen.

In what follows, the details will be described. Also, the above second example will be cited as a method for correcting the reaching time Td.

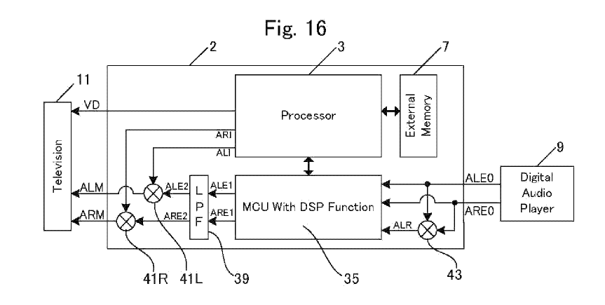

FIG. 16 is a schematic diagram for showing the electric configuration of the audio visual system in accordance with the second embodiment of the present invention. Referring to FIG. 16, this audio visual system is provided with an audio visual apparatus 2 and a television monitor 11 coupled therewith. The audio visual apparatus 2 includes a processor 3, an external memory 7, an MCU (Micro Controller Unit) 35, a lowpass filter (LPF) 39, and mixing circuits 41L, 41R and 43.

The processor 3 is coupled with the external memory V. The external memory 7, for example, is provided with a flash memory, a ROM, and/or a RAM. The external memory 7 includes a program area, an image data area, and an audio data area. The program area stores control programs for making the processor 3 execute various processes as shown in flowcharts as described below. The image data area stores all of image data which constitutes screens to be displayed on the television monitor 11, and other necessary image data. The audio data area stores audio data for sound effect and so on. The master processor 3 executes the control programs in the program area, reads the image data in the image data area and the audio data in the audio data area, performs necessary processes, and generates a video signal VD and audio signals ALT and ARI. The video signal VD is supplied to the television monitor 11 through an AV cable. The audio signals ALT and ARI are given to the mixing circuits 41L and 41R respectively.

Although not shown in the figure, the processor 3 includes various functional blocks such as a CPU (central processing unit), a graphics processor, a sound processor, and a DMA controller, and in addition to this, includes an A/D converter for receiving analog signals, an input/output control circuit for receiving input digital signals such as key manipulation signals and infrared signals and giving the output digital signals to external devices, an internal memory, and so on.

The CPU executes control programs stored in the external memory 7. The CPU receives the digital signals from the A/D converter and the digital signals from the input/output control circuit, and then executes necessary operations based on these signals in accordance with the control programs. The graphics processor performs graphics processing, which the result of the operation of the CPU requires, to the image data stored in the external memory 7 to generate the video signal VD representing images to be displayed on the television monitor 11. The sound processor performs sound processing, which the result of the operation of the CPU requires, to the audio data stored in the external memory 7 to generate the audio signals ALI and ARI representing sound effect and so on. The internal memory is, for example, a RAM, and is used as a working area, a counter area, a register area, a temporary data area, a flag area and/or the like area.

The MCU 35 has a DSP (Digital Signal Processor) for carrying out operation of digital signal processing at high speed. Audio signals ALE0 and ARE0 from the digital audio player 9 are given to the MCU 35. The MCU 35 converts the analog audio signals ALE0 and ARE0 into the digital signals, performs the pulse width modulation (PWM), generates audio signals ALE1 and ARE1 as PWM signals, and outputs to the lowpass filter 39. When the pulse width modulation is performed, the MCU 35 adjusts volume in response to a request from the processor 3.

The audio signals ALE1 and ARE1, which are PWM signals, are converted into the analog audio signals ALE2 and ARE2 by the lowpass filter 39, and given to the mixing circuits 41L and 41R respectively.

The mixing circuit 41L mixes the audio signal ALI from the processor 3 and the audio signal ALE2 from the lowpass filter 39 (corresponding to the audio signal ALE0 as input from the digital audio player 9) to output as an audio signal ALM. The mixing circuit 41R mixes the audio signal ARI from the processor 3 and the audio signal ARE2 from the lowpass filter 39 (corresponding to the audio signal ARE0 as input from the digital audio player 9) to output as an audio signal ARM. The audio signals ALM and ARM are supplied to the television monitor 11 through an AV cable (not shown in the figure).

The mixing circuit 43 mixes the audio signals ALE0 and ARE0 from the digital audio player 9 to give as an audio signal ALR to the MCU 35. The MCU 35 converts the analog audio signal ALR into the digital audio signal, and then analyzes it. Specifically, the MCU 35 detects a beat (an external beat) of the audio signal ALR to generate a beat (an internal beat) anew. Incidentally, a beat maybe called a meter generally. Also, the MCU 35 applies FFT (Fast Fourier transform) on the audio signal ALR to obtain a power spectrum. Further, the MCU 35 detects a maximum value of the audio signal ALR during a predetermined time (hereinafter one predetermined time is referred to as one frame). Incidentally, in the present embodiment, for example, it is assumed that one frame is 1/60 second. Also, in the present embodiment, for example, it is assumed that one video frame is 1/60 second. In this way, in the present embodiment, one frame in the MCU 35 coincides with one video frame in the processor 3. Thus, when there is no need to distinguish them, the term “frame” is simply used.

The MCU 35 transmits audio-related data to the processor 3 for each frame in response to the request from the processor 3. The audio-related data includes a beat bit, power, and a maximum value of the audio signal ALR during one frame. The beat bit is set to “1” at the time when the internal beat is generated, otherwise to “0”. Accordingly, a time from a value “1” of the beat bit until a next value “1” thereof corresponds to an interval of the internal beat. Incidentally, a beat interval is called a tempo generally. Also, the power is power of a frequency, which is requested by the processor 3, of the power spectrum.

Next, the method for analyzing the audio signal ALR by the MCU 35 will be described referring to the figures.

For example, the MCU 35 fetches the audio signal ALR with a sampling frequency 50 kHz. Then, the MCU 35 acquires the maximum value of the audio signal ALR during one frame for each frame. Further, the MCU 35 deducts the maximum value of the audio signal ALR during the previous frame from the maximum value of the audio signal ALR during the current frame to obtain a differential audio signal Df. However, if a level of the differential audio signal Df as obtained is 0 or less, the differential audio signal Df is set to 0. Accordingly, only when the level of the audio signal ALR rises in comparison with that of the previous frame, the level of the differential audio signal Df is larger than 0.

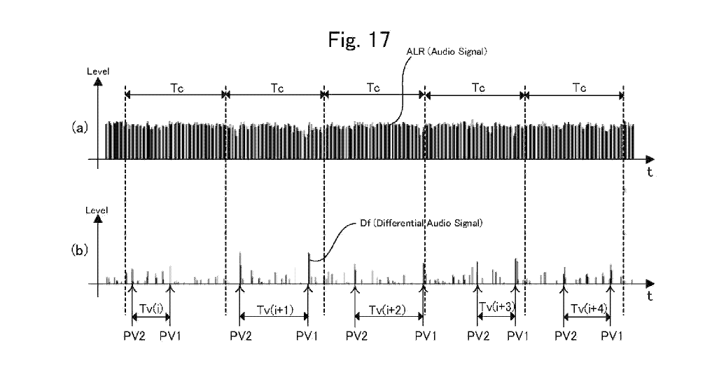

FIG. 17(a) is a wave form chart for showing the audio signal ALR to be input to the MCU 35 of FIG. 16. Referring to FIG. 17(a), a vertical axis represents the level of the audio signal ALR as input from the digital audio player 9 while a horizontal axis represents time t. A unit of the time t is a frame. However, the audio signal ALR as shown in the figure is the maximum value during one frame. FIG. 17(b) is a wave form chart for showing the differential audio signal Df as obtained from the wave of FIG. 17(a). Referring to FIG. 17(b), a vertical axis represents the level of the differential audio signal Df while a horizontal axis represents time t. A unit of the time t is a frame.

As shown in FIG. 17(a), the MCU 35 analyzes the audio signal ALR in units of a predetermined time Tc (e.g., 80 frames). That is, as shown in FIG. 17(b), the MCU 35 calculates an absolute value (Tv(i), Tv(i+1), of a difference between time PV1 (a unit is a frame) of the differential audio signal Df with the maximum level and time PV2 (a unit is a frame) of the differential audio signal Df with the second largest level, among the differential audio signals Df as obtained during the predetermined time Tc. In this case, the time PV2 of the differential audio signal Df with the second largest level is acquired from outside a range of ±B frame (e.g., 5) whose center is the time PV1 of the differential audio signal Df with the maximum level, within the predetermined time Tc.

In this way, the MCU 35 regards the differential audio signal Df with the maximum level and the differential audio signal Df with the second largest level within the predetermined time Tc as the beats of the audio signal ALR. Thus, the beat of the audio signal ALR which is obtained based the result of the analysis is referred to as the “external beat”. Also, the original beat of the audio signal ALR may be referred to as the “original beat” due to distinguish the original beat of the audio signal ALR from the external beat and the internal beat described below.

Accordingly, each of the absolute values Tv(i), Tv(i+1), . . . is the interval of the external beat, i.e., the tempo of the external beat. The term “external beat interval Tv” is used to generally represent the external beat intervals Tv(i), Tv(i+1), . . . .

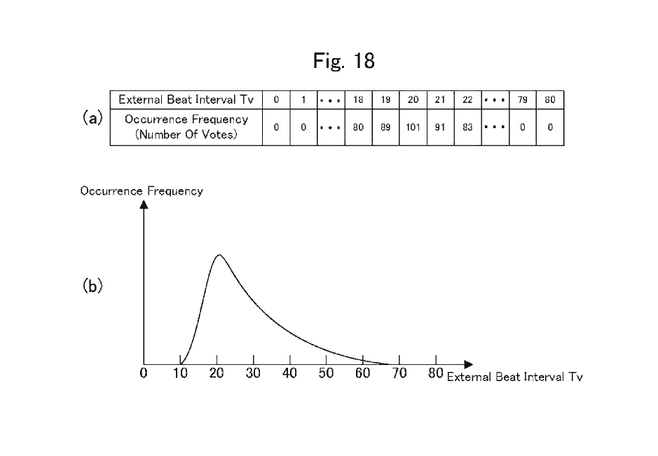

And, the MCU 35 updates an occurrence frequency table shown in FIG. 18(a) every time the external beat interval Tv is detected, i.e., at every the predetermined time Tc. That is, the MCU 35 votes (adds) one point to the detected external beat interval Tv in the occurrence frequency table. Accordingly, the number of votes (points) in the occurrence frequency table represents an occurrence frequency of each external beat interval Tv. When the occurrence frequency table is graphed, it is shown in FIG. 18(b). It is possible to easily recognize distribution of the occurrence frequency of the external beat interval TV from this graph.

The MCU 35 sets a temporary internal beat interval Tu to the external beat interval Tv which occurs with highest frequency, i.e., to which the number of the votes (points) is greatest. In this way, the temporary internal beat interval Tu, which is obtained by applying the statistical processing to the external beat interval Tv, is temporarily regarded as the interval of the original beat of the audio signal ALR. Then, the MCU 35 predicts time when the original beat will occur in the immediate future, based on the temporary internal beat interval Tu. The MCU 35 generates the internal beat at the time when such predicted original beat is occurred. In this way, the internal beat is a beat which is generated at the time predicted by the MCU 35.

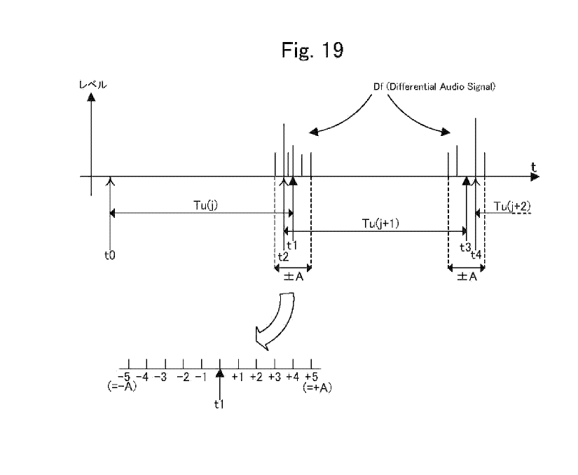

FIG. 19 is a detail-explanatory view showing a method for generating the internal beat. In this case, a unit of time t is a frame. Also, the term “temporary internal beat interval Tu” is used to generally represent the temporary internal beat intervals Tu(j), Tu(j+1), . . . . Referring to FIG. 19, it is assumed that the MCU 35 generates the internal beat at the time t1 of the elapse of the temporary internal beat interval Tu(j) from the time t0. In this case, the MCU 35 detects the maximum level of the differential audio signal Df from the range of ±A frame (e.g., 5) whose center is the time t1 when the internal beat is generated. Then, the MCU 35 generates the internal beat at the time t3 of the elapse of the latest temporary internal beat interval Tu(j+1) at the time t2 from the time t2 of the differential audio signal Df with the maximum level. Accordingly, a time from time when the internal beat is generated at time t1 until time when the internal beat is generated at time t3 may not coincide with the temporary internal beat interval Tu. A time from time when the internal beat is generated until time when a next internal beat is generated is referred to as an “internal beat interval Tt”.

In this way, the final internal beat interval Tt is determined by adjusting the base point of the temporary internal beat interval Tu every time the internal beat is generated, and thereby it is possible to eliminate accumulation of an error which occurs between the internal beat and the original beat. Also, at the time when the internal beat is generated at time t1, the MCU 35 determines the time t3 when the next internal beat is generated. That is, the MCU 35 regards the internal beat interval Tt obtained by adjusting the latest temporary internal beat interval Tu at the time t1 when the internal beat is generated as the original beat, predicts that the time t3 of the elapse of the internal beat interval Tt from the generation time t1 of the internal beat is the time when the original beat will occur in the immediate future, and generates the next internal beat at time t3.

Next, the process flow of the MCU 35 will be described using flowcharts.

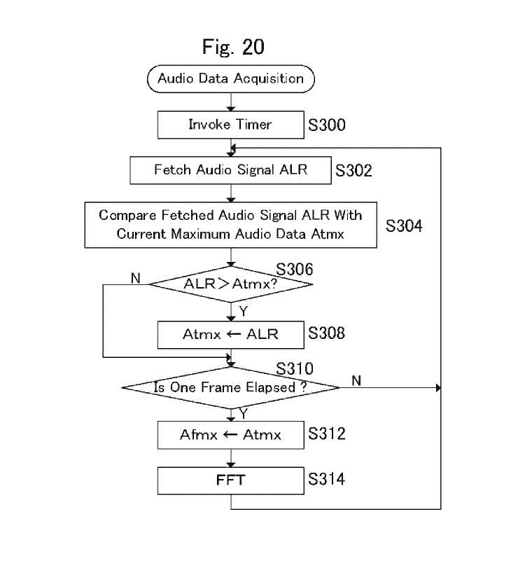

FIG. 20 is a flow chart showing a process for acquiring audio data by the MCU 35 of FIG. 16. Referring to FIG. 20, in step S300, the MCU 35 invokes a timer. This timer notifies the MCU 35 of elapse of one frame. In step S302, the MCU 35 fetches the audio signal ALR as output from the mixing circuit 43 of FIG. 16 (sampling). In step S304, the MCU 35 compares the level of the fetched audio signal ALR with the level of the current maximum audio data Atmx. In step S306, the MCU 35 proceeds to step S308 if the level of the audio signal ALR exceeds the level of the maximum audio data Atmx, otherwise proceeds to step S310. Instep S308, the MCU 35 assigns the audio signal ALR to the maximum audio data Atmx.

In step S310, the MCU 35 determines whether or not one frame is elapsed, the process returns to step S302 if it is not elapsed, i.e., if the MCU 35 does not receive the notification from the timer, conversely the process proceeds to step S312 if it is elapsed, i.e., the MCU 35 receives the notification from the timer. Incidentally, the maximum audio data Atmx at the time when it is determined instep S310 that one frame has been elapsed is the maximum value of the audio signal ALR during one frame.

In step S312 after determining “YES” in step S310, the MCU 35 assigns the maximum audio data Atmx to the variable Afmx. In step S314, the MCU 35 applies the FFT on the audio signal ALR within one frame to obtain the power spectrum, and then returns to step S302.

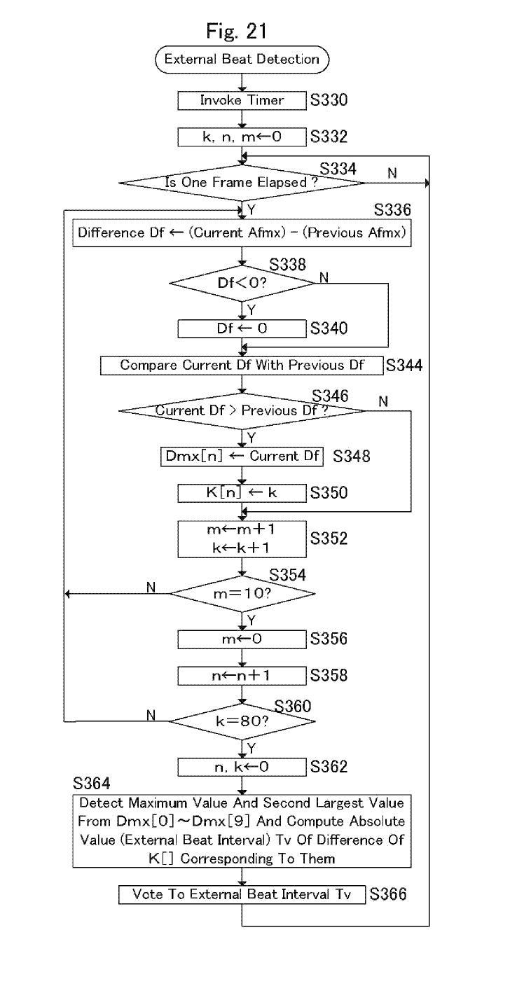

FIG. 21 is a flow chart showing a process for detecting the external beat by the MCU 35 of FIG. 16. Referring to FIG. 21, in step S330, the MCU invokes a timer. This timer notifies the MCU 35 of elapse of one frame. In step S332, the MCU 35 assigns “0” to the variables k, n, and m. In step S334, the MCU 35 proceeds to step S336 if one frame is elapsed (there is the notification from the timer), conversely returns to step S334 if it is not elapsed (there is no notification from the timer).

In step S336, the MCU 35 subtracts the previous value of the variable Afmx (the maximum audio data Atmx within the previously one frame) from the latest value of the variable Afmx (the maximum audio data Atmx within the currently one frame), and assigns the result of the operation of subtraction to the variable (difference) Df. In step S338, the MCU 35 determines whether or not the difference Df is less than 0, the process proceeds to step S340 if it is less than 0, otherwise the process proceeds to step S344. In step S340, the MCU 35 assigns “0” to the difference Df.

In step S344, the MCU 35 compares the current difference Df with the previous difference Df. Then, in step S346, the process proceeds to step S348 if the current difference Df is larger than the previous difference Df, otherwise the process proceeds to step S352. In step S348, the MCU 35 assigns the current difference Df to the variable Dmx[n]. In step S350, the MCU 35 assigns the value of the variable k to the variable K[n].

In step S352, the MCU 35 increases the variables m and k by one respectively. In step S354, the MCU 35 determines whether or not the variable m becomes 10, the process proceeds to step S356 if it becomes 10, conversely the process proceeds to step S336 if it does not become 10. In step S356, the MCU 35 assigns “0” to the variable m. In step S358, the MCU 35 increases the variable n by one.

In step S360, the MCU 35 determines whether or not the value of the variable k becomes 80, the process proceeds to step S362 if it becomes 80, conversely the process proceeds to step S336 if it does not become 80. In step S362, the MCU 35 assigns “0” to the variables n and k respectively.

In step S364, the MCU 35 detects the maximum value and the second largest value from the variables Dmx[0] to Dmx[9], and calculates the absolute value of the difference between the value PV1 of the variable K[ ] corresponding to the maximum value and the value PV2 of the variable K[ ] corresponding to the second largest value, i.e., the external beat interval Tv. For example, when the maximum value is Dmx[2] and the second largest value is Dmx [6], the absolute value of the difference (K[2] minus K [6]) is the external beat interval Tv. In step S366, the MCU 35 votes one point to the external beat interval Tv as calculated in step S364 in the occurrence frequency table (see FIG. 18(a)), and then returns to step S334.

The supplementary description of the above step S354 will be made. This step is implemented so as to obtain the maximum value of the differences Df during 10 frames (step S346) to assign it to the variable Dmx[n], and assign the value (i.e., frame time) of the variable k at that time to the variable K[n]. Thus, the variable n is increased every 10 frames (step S358), and the variable m is reset every 10 frames (step S356).

The supplementary description of the above step S360 will be made. This step is implemented so as to obtain the external beat interval Tv (step S364) every 80 frames, i.e., every the time Tc (see FIG. 17). Thus, the variables n and k are reset every 80 frames (step S362).

By the way, the maximum value of the differences Df is obtained in units of 10 frames by implementing the step S354 because of the following reason. It needs to obtain the maximum value and the second largest value of the differences Df during the time Tc (see FIG. 17). In this case, as described above, the time PV2 of the difference Df with the second largest level is acquired from outside a range of ±B frame whose center is the time PV1 of the difference Df with the maximum level. In this flowchart, B=5. Thus, when the maximum values Dmx[0] to Dmx[9] of the differences Df in 80 frames are acquired by acquiring the maximum value of the differences Df in units of 10 frames, the maximum value and the second largest value are acquired from them in step S364.

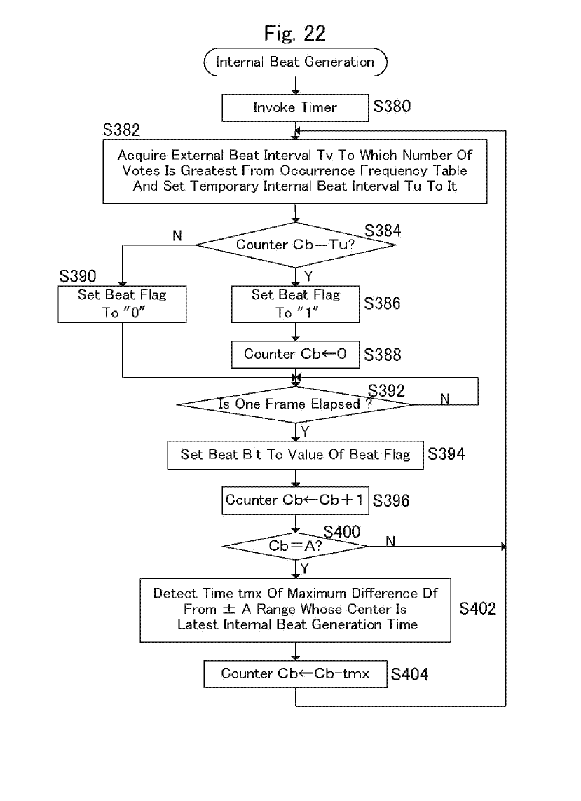

FIG. 22 is a flow chart showing a process for generating the internal beat by the MCU 35 of FIG. 16. Referring to FIG. 22, in step S380, the MCU 35 invokes a timer. This timer notifies the MCU 35 of elapse of one frame. In step S382, the MCU 35 acquires the external beat interval Tv to which the number of the votes (points) is greatest from the occurrence frequency table (see FIG. 18(a)), and sets the temporary internal beat interval Tu to it. Incidentally, a unit of the external beat interval Tv and the temporary internal beat interval Tu is a frame.

In step S384, the MCU 35 determines whether or not a counter Cb coincides with the temporary internal beat interval Tu as set in step S382, the process proceeds to step S386 if it coincides, conversely the process proceeds to step S390 if it does not coincide. In step S386, the MCU 35 sets the beat flag to “1”. In step S388, the MCU 35 sets the counter Cb to “0”. On the other hand, in step S390, the MCU 35 sets the beat flag to

In step S392, the MCU 35 proceeds to step S394 if one frame is elapsed (there is the notification from the timer), conversely returns to step S392 if it is not elapsed (there is no notification from the timer). In step S394, the MCU 35 sets the beat bit to the value of the beat flag. In this case, when the value of the beat flag indicates “1” and additionally the beat bit is set to “1”, it means the generation of the internal beat. In step S396, the MCU 35 increases the counter Cb by one.

In step S400, the MCU 35 determines whether or not the counter Cb coincides with the constant A, the process proceeds to step S402 if it coincides, otherwise the process proceeds to step S382. In step S402, the MCU 35 detects a time tmx of the maximum difference Df from the range of ±A frame whose center is the time when the latest internal beat is generated (see FIG. 19).

In this case, a unit of the time tmx is a frame. Also, it is assumed that the time when the latest internal beat is generated is “0”, and times in a positive direction are defined as 1, 2, . . . , A while times in a negative direction are defined as −1, −2, . . . , −A. Accordingly, the time tmx is a value with a positive sign or a negative sign.

Then, in step S404, the MCU 35 subtracts the time tmx from the current value of the counter Cb, and then returns to step S382. In this way, as described above, the base point of the temporary internal beat interval Tu is adjusted by correcting the value of the counter Cb every time the internal beat is generated, and thereby it is possible to reduce the accumulation of the error which occurs between the internal beat and the original beat. By such adjustment, eventually, the internal beat is generated at the internal beat interval Tt. Incidentally, needless to say, the internal beat interval Tt may be obtained by adding the time tmx to the temporary internal beat interval Tu instead of the adjustment of the counter Cb.

Next, the process flow of the processor 3 will be described using flowcharts.

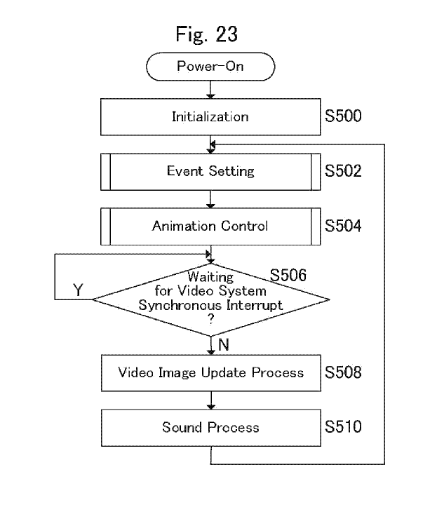

FIG. 23 is a flowchart showing a process of the processor 3 of FIG. 16. Referring to FIG. 23, in step S500, the processor 3 performs the initial settings of the system. In this step S500, variables, counters, timers, flags, and so on are initialized.

In step S502, the processor 3 sets the event in accordance with the audio-related data as acquired from the MCU 35. In step S504, the processor 3 controls the animation in which the character 102 swings the stick 104 in accordance with the setting of the event of step S502.

In step S506, the processor 3 determines whether or not the interrupt based on the video system synchronous signal is waited for, the processor 3 returns to step S506 if the state is a state of waiting for the interrupt, conversely, if the state is not the state of waiting for the interrupt, i.e., if the interrupt based the video system synchronous signal is given, in step S508, the processor 3 updates the images to be displayed on the television monitor 11 on the basis of the results of the processes of steps S502 and S504 while the processor 3 performs the sound processing with regard to the sound effect and so on in step S510, and then the processor 3 proceeds to step S502.

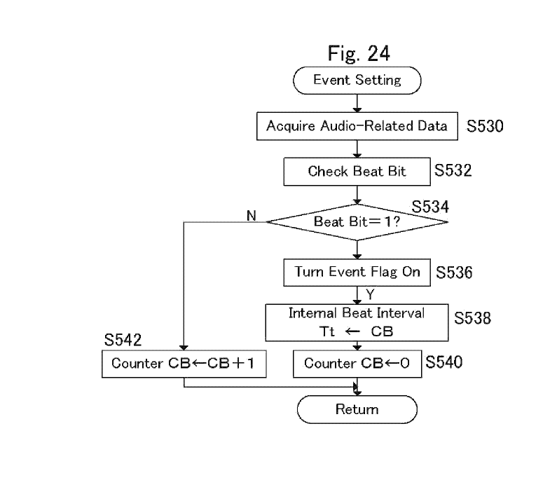

FIG. 24 is a flow chart showing a process of step S502 of FIG. 23. Referring to FIG. 24, in step S530, the processor 3 acquires the audio-related data from the MCU 35. As described above, the audio-related data contains the beat bit, the power, and the maximum value of the audio signal ALR within one frame. In step S532, the processor 3 checks the value of the beat bit. In step S534, the processor 3 proceeds to step S536 if the beat bit indicates “1”, i.e., if the internal beat is generated, conversely proceeds to step S542 if it indicates “0”.

In step S536, the processor 3 turns the event flag on to set the event. In step S538, the processor 3 sets the internal beat interval Tt to the value of the counter CB. In this way, the counter CB is a counter for counting a time (a unit thereof is a frame) from time when the beat bit becomes “1” until time when it next becomes “1”, i.e., the internal beat interval Tt. Accordingly, the value of the counter CB in step S538 indicates a time from time when the beat bit previously becomes “1” until time when the beat bit currently becomes “1”.

In step S540, the processor 3 assigns “0” to the counter CB, and then returns. On the other hand, in step S542, the processor 3 increases the counter CB by one, and then returns.

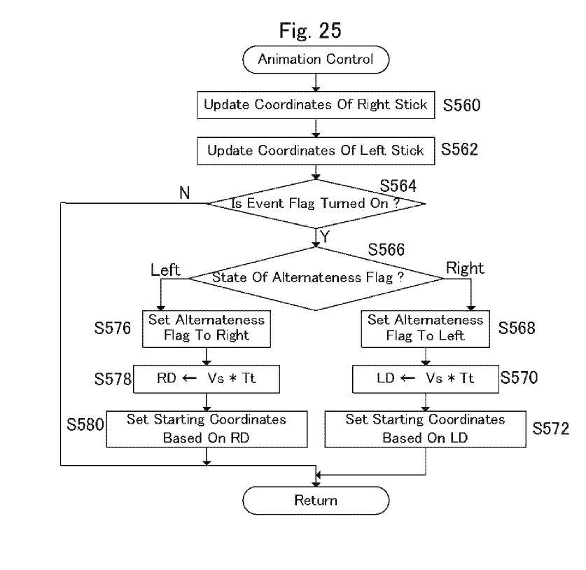

FIG. 25 is a flow chart showing the process of step S504 of FIG. 23. Referring to FIG. 25, in step S560, the processor 3 updates xy coordinates of the stick 104R. In step S562, the processor 3 updates xy coordinates of the stick 104L.

In step S574, the processor 3 checks whether or not the event flag is turned on, the process proceeds to step S566 if it is turned on, conversely the process returns if it is turned off. In step S566, the processor 3 checks an alternateness flag, the process proceeds to step S568 if the alternateness flag indicates the right stick 104R, conversely the process proceeds to step S576 if the alternateness flag indicates the left stick 104L. The alternateness flag indicates a stick which starts to move based on the previous event.

In the case where the alternateness flag indicates the right stick 104R, in step S568, the processor 3 sets the alternateness flag to the value indicating the left stick 104L. Then, instep S570, the processor 3 multiplies the moving velocity Vs of the stick 104L by the internal beat interval Tt to calculate the moving distance LD. In the present embodiment, the moving velocity Vs is constant regardless of the beat. Accordingly, the strike of the drum object 106L by the stick 104L is conformed to the beat by adjusting the moving distance LD on the basis of the beat. In step S572, the processor 3 calculates the coordinates for starting to swing the stick 104L down on the basis of the moving distance LD to set.

On the other hand, in the case where the alternateness flag indicates the left stick 104L, in step S576, the processor 3 sets the alternateness flag to the value indicating the right stick 104R. Then, in step S578, the processor 3 multiplies the moving velocity Vs of the stick 104R by the internal beat interval Tt to calculate the moving distance RD. In the present embodiment, the moving velocity Vs is constant regardless of the beat. Accordingly, the strike of the drum object 106R by the stick 104R is conformed to the beat by adjusting the moving distance RD on the basis of the beat. In step S580, the processor 3 calculates the coordinates for starting to swing the stick 104R down on the basis of the moving distance RD to set.

By the way, as described above, in accordance with the present embodiment, the audio signal ALR such as music is input from outside (in the above example, the digital audio player 9). Thus, the user can enjoy the image together with his/her favorite music, and input the different music to enjoy if the user feels bored.

Also, in the present embodiment, the occurrence timing of the beat of the external input audio signal ALR is predicted, then the event is set based on the result of the prediction, and thereby it is possible to perform the real-time processing. Therefore, it is possible to be small the scale of the storage means such as a memory, and reduce the cost because a device for playing back the stored audio signal ALR is not required, in comparison with the case where the audio signal ALR is played back and the event is set after storing temporarily and analyzing the audio signal ALR. Incidentally, in the case where the input audio signal ALR is temporarily stored and analyzed, subsequently, the audio signal ALR is played back, and the event is set, a delay occurs because of the storing, analyzing, and playing back, and therefore it is not the real-time processing.

Also, in the present embodiment, the generation of the internal beat (see FIG. 22) corresponds to the prediction of the occurrence timing of the beat of the audio signal ALR. Because, it is predicted (regarded) that the beat of the audio signal ALR will occur at the time of the elapse of the temporary internal beat interval Tu as obtained on the basis of the occurrence frequency table (step S382 of FIG. 22) from the time when the internal beat is generated (step S388 of FIG. 22), and the occurrence of the beat as predicted is notified the processor 3 by the internal beat as generated at the time when the temporary internal beat interval Tu is elapsed (steps S386 and S394 of FIG. 22).

However, substantially, it is predicted that the beat of the audio signal ALR occurs at the time of the elapse of the internal beat interval Tt from the time when the internal beat is generated, and the occurrence of the beat as predicted is notified the processor 3 by the internal beat as generated at the time when the internal beat interval Tt is elapsed. Because the counter Cb is corrected in steps S402 and S404 of FIG. 22.

And, the event is set at the time when the internal beat is generated, i.e., when the beat bit indicates “1” (step S536 of FIG. 24). The generation of the internal beat corresponds to the prediction of the occurrence timing of the beat of the audio signal ALR, and therefore it can be considered that the event is set based on the prediction result of the occurrence timing of the beat of the audio signal ALR.

Further, since the occurrence timing of the beat of the external input audio signal ALR is predicted, while performing the real-time processing, it is possible to effect the certain result, i.e., the strike of the drum object 106 by the stick 104, at the occurrence timing of the future beat of the external input audio signal ALR.

In this way, the strike of the drum object 106 by the stick 104 is conformed to the beat by predicting the occurrence timing of the beat. Accordingly, a time from the strike of the drum object to the strike of the adjacent drum object coincides with the cycle of the beat. That is, the serial events are set so that said time coincides with the cycle of the beat.

Also, in the present embodiment, the event is set so that the time from the time when the event is set until the time when the stick 104 strikes the drum object 106, i.e., the reaching time Td coincides with the cycle of the beat of the audio signal ALR, i.e., the internal beat interval Tt (steps S570, S572, S578, and S580 of FIG. 25). The setting of the event in this case includes the settings in steps S572 and S580 as well as the operation of turning the event flag on.

Thus, the reaching time Td differs depending on the speed (tempo) of the beat of the audio signal ALR. Accordingly, when the beat of the audio signal ALR differs, the animation within the reaching time Td also differs, and thereby it is possible to give the different expression and effect by the animation depending on the audio signal ALR.

For example, in the case where the audio signal ALR is music, the reaching time Td depends on the tempo of the music. Thus, when the tempo of the music differs, the animation within the reaching time Td also differs, and thereby it is possible to give the different expression and effect for each music piece.

Further, in the present embodiment, since the beat of the audio signal ALR is detected based on the amplitude of the audio signal ALR (the differential audio signal Df) (see FIG. 17), it is possible to reduce the processing load in comparison with the detection by the frequency analysis and furthermore reduce software and/or hardware.

Still further, in accordance with the present embodiment, a time from a beat to a beat of the audio signal ALR, i.e., the external beat interval Tv is detected based on the amplitude of the audio signal ALR (the differential audio signal Df) (see FIG. 17), and then the temporary internal beat interval Tu and furthermore internal beat interval Tt are determined based on the occurrence frequency of the external beat interval Tv as detected (see FIGS. 18 and 19).

In this way, the cycle of the audio signal ALR, i.e., the internal beat interval Tt is determined based on the occurrence frequency of the external beat interval Tv as detected, i.e., the statistical result. Thus, it is possible to determine the highly reliable and stable cycle.

Yet still further, in accordance with the present embodiment, the currently predicted occurrence timing of the beat of the audio signal ALR (i.e., the internal beat to be generated currently) is corrected (see FIG. 19) taking, as a base point, a time when the amplitude of the audio signal ALR (the differential audio signal Df) within the predetermined range including the previously predicted beat of the audio signal ALR (i.e., the previously generated internal beat) is largest.

Therefore, the deviation (error) between the previously predicted occurrence timing of the beat of the audio signal ALR and the actual occurrence timing of the beat of the audio signal ALR is corrected by the currently prediction, and thereby it is possible to reduce the accumulation of the deviation as much as possible.

Meanwhile, the present invention is not limited to the above embodiment, and a variety of variations may be effected without departing from the spirit and scope thereof, as described in the following modification examples.

(1) As is obvious from the descriptions of the embodiments, the audio visual apparatuses 1 and 2 can be called a timing controller. Because, the event is set so as to coincide with the future beat of the music, and thereby the certain result is effected. In this case, the certain result means that an object to be controlled becomes a predetermined state. The term “predetermined state” contains a predetermined appearance, a predetermined position, predetermined sound, and so on.

(2) In the above case, music is cited as an example of sound (audio) to be input from outside. However, it is not limited to music, and may be the other audio such as acousmato, voice, and sound. However, it is preferable that they have a beat (meter).

Also, in the above case, the external audio signal is input from the digital audio player 9. However, it may be input from the other recording medium such as a CD player and a DVD player. Also, audio is converted into the electrical signal by a microphone, and it may be the input audio signal from outside. Further, the external audio signal may be supplied through a communication line such as LAN and Internet.

(3) In the above case, the change of the predetermined image, i.e., the stick 104 is controlled in response to the event as set, and the predetermined result, i.e., the reaching of the stick 104 to the drum object 106 is effected at the predicted occurrence timing of the beat. However, the predetermined image to be controlled is not limited to the stick 104, and any image may be controlled. Also, the number of the predetermined images to be controlled is not limited to two images, and may be one, or a plural number other than two.

In the case where the number of the predetermined images is plural, it is possible to conform a time when the certain result is effected to the beat regardless of the length of the cycle of the beat of the audio signal. For example, it is assumed that one predetermined image is commonly used for all events. When the cycle of the beat is too short, a time from one event to the next event is also short. If it does, before effecting the certain result corresponding to one event, the next event may be set. That is, before the predetermined image effects the certain result in response to one event, the predetermined image has to been started to be controlled in response to the event as set next. As the result, it is not possible to effect the certain result at the timing of the beat.

In the above case, two sticks 104 are alternately moved, and they are invariably displayed on the screen. However, a predetermined image as an object to be controlled may be prepared anew for each event which is sequentially set based on the prediction result. When each predetermined image effects the certain result, each may be used only once by the elimination or the like without being returned to the initial position. In this case, it is possible to confirm the time when the predetermined result is effected to the beat regardless of the length of the cycle of the beat of the audio signal. For example, it is assumed that one predetermined image is commonly used for all events. When the cycle of the beat is too short, a time from one event to the next event is also short. If it does, before effecting the certain result corresponding to one event, the next event may be set. That is, before the predetermined image effects the certain result in response to one event, the predetermined image has to been started to be controlled in response to the event as set next. As the result, it is not possible to effect the certain result at the timing of the beat.

For example, a predetermined image, which descends vertically toward the lower end of the screen in response to the setting of the event, may be an object to be controlled. In this case, the event is set so that the predetermined image reaches a predetermined vertical coordinate (hereinafter a position of the predetermined vertical coordinate on a moving path is referred to as “timing position”) at the predicted occurrence timing of the beat. And, the predetermined image disappears at the lower end of the screen. In this example, the moving path (in this example, a straight line extending in a vertical direction (nondisplay))of the predetermined image which descends is not limited to one path, and a plurality of paths may be implemented.

In this example, in addition, an image which responds to the operation of the user (hereinafter referred to as “response image”) may be displayed at the timing position. In this case, for example, the user operates the response image at the timing when the predetermined image reaches the response image, and thereby can hit back the predetermined image. Since the timing when the predetermined image reaches the timing position coincides with the beat of the music, if the user operates the response object at the timing when the predetermined image reaches the response image, the operation is along to the beat of the music, and therefore it is possible to enjoy the operation along to the beat of music.

In what follows, in this example, some means for operating the response image will be described. For example, the response object maybe operated by a general controller having a joystick, arrow keys, and so on for a game machine. Also, for example, a controller, which has a predetermined number of input parts (e.g., switches) each of which detects the input operation of the user, may be used. The controller receives operation signals from the respective input parts to give them to the processor 3. The processor 3 displays the response images which respond to the operation signals of the respective input parts from the controller. In this case, for example, four response images are horizontally aligned at the timing positions, and four input parts corresponding to the four response images are prepared. The each response image responds to only the operation of the corresponding input part. Incidentally, such controller may have the input parts to be operated by a hand of the user, or be a mat-type controller to be operated by treading on with a foot.

Also, for example, a controller may have an acceleration sensor, and it is also possible to make the response image change (respond) as a trigger that the acceleration of the controller moved by the user exceeds a predetermined value.

In the above example, the response image is arranged at the timing position. However, the response image may interlock with the motion of the user like a cursor. In this case, the user matches the response image to the predetermined image at the timing when the predetermined image reaches the timing position, and thereby can enjoy the operation along to the music. In this case, it is preferable that a certain image is displayed on the timing position for convenience of the user.

In what follows, in this example, some means for operating the response image will be described. For example, the response object maybe operated by a general controller having a joystick, arrow keys, and so on for a game machine. Also, for example, an imaging device such as CCD and an image sensor images motion of the user, the motion of the user is detected by analyzing the image, and the response image interlocks with the motion. In this case, a retroreflective member is grasped by or attached to the user, a light-emitting device (e.g., infrared light emitting diode) intermittently irradiates it with light (e.g., infrared light), and the movement of the retroreflective member, i.e., the user is detected based on a differential image between an image at the light emitting period and an image at the non-light emitting period (differential processing). However, a apparatus having a light-emitting device such as an infrared light emitting diode may be attached to or grasped by the user in place of the retroreflective member. In this case, since the difference processing is not required, the light-emitting device for performing the differential processing is unnecessary.

Incidentally, although the above stroboscope imaging (the blinking of the light-emitting device) and the differential processing are cited as the preferable example, these are not essential elements. That is, the light-emitting device does not have to blink, or there may be no need of the light-emitting device. Light to be emitted is not limited to the infrared light. Also, the retroreflective member is not essential element if it is possible to detect an input device grasped by the user or a certain part (e.g., hand or foot) of a body by analyzing the photographed image.

Further, for example, an electronic device in which an imaging device is implemented is held by the user, it may be used as an input device for operating the response image. In this case, a plurality of markers is attached along an edge of a screen of a television monitor. The makers are photographed by the imaging device of the input device, the processor determines which position on the screen the user indicates, and displays the response image thereon. The marker is, for example, a light-emitting device such as an infrared light diode. Also, the marker may be a retroreflective member. In this case, a light-emitting device is installed in the input device. Further, the differential image may be processed by blinking the light-emitting device.

(4) In the above case, the position of the predetermined image (the stick 104), which is an object to be controlled, changes in response to the event (swinging down and up). However, it is not limited to a movement which is a change of a position, an appearance of the predetermined image, which is an object to be controlled, may change in response to the event. The term “appearance” is used as a term including shape, pattern, and color.

### FIRST MODIFICATION EXAMPLE

For example, a predetermined image having a predetermined shape appears at a prescribed position or any position on a screen, in addition to it, a graphic similar to the predetermined image is displayed as a timing indicating object at the same center position. At the same time, the predetermined image changes toward the timing indicating object. In this case, the predetermined image enlarges if the timing indicating object is larger than the predetermined image, conversely the predetermined image shrinks if it is smaller. In this case, the event is set so that the timing when the predetermined image reaches the timing indicating object coincides with the beat of music.

### SECOND MODIFICATION EXAMPLE

For example, a predetermined image having a first predetermined pattern appears at a prescribed position or any position on a screen, in addition to it, a timing indicating object having a second predetermined pattern is displayed close to the predetermined image. At the same time, a pattern of the predetermined image changes from the first predetermined pattern toward the second predetermined pattern. In this case, the event is set so that the timing when the pattern of the predetermined image becomes the pattern of the timing indicating object, i.e., the second predetermined pattern coincides with the beat of music.

### THIRD MODIFICATION EXAMPLE

A color of the predetermined image may change. In this case, the same example as the case where the pattern of the predetermined image changes is applied. That is, in the above example with regard to the pattern, the term “pattern” is replaced by the term “color”.

### FOURTH MODIFICATION EXAMPLE

The above response image may be displayed also in the first to third modification examples. In this case, the response image may be operated by the above means.

(5) In the above case, an object to be controlled is a predetermined image (the stick 104). However, the object to be controlled is not limited to an image. For example, sound, an external device, an external computer program, thing, material (solid, liquid, and gas) or the like may be optionally employed as the object to be controlled.

(Sound as an Object to be Controlled)

The timing controller 1 or 2 predicts the occurrence timing of the beat of the audio signal, and sets the event based on the prediction result. For example, at least one of timing for starting to output predetermined sound and timing for starting to change predetermined sound is determined based on the predicted occurrence timing of the beat, and the event is set based on the determination result. Then, the timing controller 1 or 2 controls the predetermined sound in response to the event, and allows the predetermined sound to effect the predetermined result at the predicted occurrence timing of the beat. In this way, since the occurrence timing of the beat is predicted, while performing the real-time processing, it is possible to allow the predetermined sound to effect the predetermined result at the timing of the future beat of the audio signal. For example, the control of the predetermined sound is control of an element (s) such as amplitude (volume), waveform (tone color), and/or a cycle (pitch). Accordingly, the predetermined result is that the element of the sound becomes a predetermined state.

(Specific Thing or Specific Material as an Object to be Controlled)

The timing controller 1 or 2 predicts the occurrence timing of the beat of the audio signal, and sets the event based on the prediction result. For example, at least one of timing for starting a change, appearance timing, a position for starting a change, a trajectory, velocity, and acceleration of predetermined thing or material is determined based on the predicted occurrence timing of the beat, and the event is set based on the determination result. Then, the timing controller 1 or 2 controls the change of the predetermined thing or material in response to the event, and effects the predetermined result at the predicted occurrence timing of the beat. The change of the predetermined thing or material contains change of a position and/or appearance. In this way, since the occurrence timing of the beat is predicted, while performing the real-time processing, it is possible to allow the predetermined thing or material to effect the predetermined result at the timing of the future beat of the audio signal. Incidentally, in the case where the predetermined material is gas, for example, the gas can be controlled by enclosing in a container and so on.

For example, in the case where the object to be controlled is a waterdrop, it falls from a first predetermined position to a second predetermined position. In this case, the event is set so that the time when the waterdrop reaches the second predetermined position coincides with the beat of the music. In this case, the waterdrop falls from the first predetermined position in response to the setting of the event. In this example, for example, the term “waterdrop” may be replaced by the term “ball”, or “container in which gas is enclosed”. Also, for example, in the case where the object to be controlled is a jet of water, the event is set so that the time when the jetted water ascends, then descends, and further then reaches the surface of the water coincides with the beat of the music. In this case, the water is jetted in response to the setting of the event.

The waterdrop, the water, and so on is not directly controlled, and the mechanism such as opening and closing of a valve such as a solenoid valve is directly controlled. Such fact is true also with regard to the other predetermined thing and material, they are directly not controlled, and a mechanism, a machine, a device and/or a computer program, and so on for controlling them is controlled and driven in response to the event.

(External Device and/or External Computer Program as an Object to be Controlled)

The timing controller 1 or 2 predicts the occurrence timing of the beat of the audio signal, and sets the event based on the prediction result. This point is the same as the above case. Then, the timing controller 1 or 2 controls an external device and/or an external computer program in response to the event, and effects the predetermined result at the predicted occurrence timing of the beat. In this way, since the occurrence timing of the beat is predicted, while performing the real-time processing, it is possible to make the external device and/or the external computer program effect the predetermined result at the timing of the future beat of the audio signal.

(6) In the above case, the audio signal is input from outside, the frequency thereof is analyzed, and then the future occurrence timing of the beat is predicted. However, a signal to be input from outside is not limited to an audio signal. For example, the signal to be input from outside may be an operated signal of a switch. The switch is, for example, a switch of a hand-input-type controller such as a controller for a game machine, a foot-input-type switch such as a foot switch, a switch of a keyboard, and so on.

Also, for example, the signal to be input from outside may be a trigger signal which is generated when a predetermined condition is satisfied. The trigger signal is, for example, a signal which is generated when movement of an input device satisfies predetermined condition. The predetermined condition is, for example, that an acceleration of an input device exceeds a predetermined value. In this case, an acceleration sensor is implemented in the input device.

(7) The audio visual apparatuses 1 and 2 may be provided with an imaging means such as an image sensor for imaging a subject. In this case, the processor 3 analyzes the photographed image to detect movement of the subject. Accordingly, in this case, an object to be analyzed a frequency is not an audio signal as input from outside but a trigger signal which is generated when an image of the subject satisfies a predetermined condition.

(8) In the second embodiment, the processor 3 performs the processing shown in FIG. 24. However, instead of the processing, the MCU 35 may compute the internal beat interval Tt, and give the internal beat interval Tt together with the beat bit to the processor 3. When the beat bit indicating “1” (internal beat) is given to the processor 3, it represents the incidence of the event. Also, the processes of the above processor 3 and the MCU 35 may be performed by any one of them.

While the present invention has been described in detail in terms of embodiments, it is apparent that those skilled in the art will recognize that the invention is not limited to the embodiments as explained in this application. The present invention can be practiced with modification and alteration within the spirit and scope of the present invention as defined by the appended any one of claims.

1. A timing controller, comprising:
a predicting unit operable to analyze an audio signal as input from outside, detect cyclic repetition of the audio signal, and predict occurrence timing of a base point of the cyclic repetition;
a setting unit operable to set an event on the basis of the occurrence timing as predicted;
a controlling unit operable to perform a predetermined control in response to the set event to effect a predetermined result at the occurrence timing as predicted.

2. The timing controller as claimed in claim 1, wherein the setting unit sets the each event so that a time from time when the predetermined result is effected until time when the predetermined result is next effected coincides with a cycle of the cyclic repetition of the audio signal.

3. The timing controller as claimed in claim 1, wherein the predetermined control is control of a predetermined image, and
wherein the controlling unit controls the predetermined image in response to the set event to allow the predetermined image to effect the predetermined result at the occurrence timing as predicted.

4. The timing controller as claimed in claim 3, wherein the controlling unit controls change of the predetermined image in response to the set event to effect the predetermined result at the occurrence timing as predicted, and
wherein the change of the predetermined image includes change of a position and/or an appearance.

5. The timing controller as claimed in claim 3, wherein the setting unit determines a change-start timing, appearance timing on a screen, change-start position, a trajectory, velocity, or acceleration of the predetermined image on the basis of the occurrence timing as predicted, and sets the event on the basis of a result of the determination.

6. The timing controller as claimed in claim 1, wherein
the predetermined control is control of predetermined sound, and wherein the controlling unit controls the predetermined sound in response to the set event to allow the predetermined sound to effect the predetermined result at the occurrence timing as predicted.

7. The timing controller as claimed in claim 6, wherein the setting unit determines an output-start timing or change-start timing on the basis of the occurrence timing as predicted, and sets the event on the basis of a result of the determination.

8. The timing controller as claimed in claim 1, wherein the predetermined control is control of an external device and/or an external computer program, and
wherein the controlling unit controls the external device and/or the external computer program in response to the set event to effect the predetermined result at the occurrence timing as predicted.

9. The timing controller as claimed in claim 1, wherein the predetermined control is control of a predetermined thing or a predetermined material, and
wherein the controlling unit controls the predetermined thing or the predetermined material in response to the set event to effect the predetermined result at the occurrence timing as predicted.

10. The timing controller as claimed in claim 9, wherein the controlling unit controls change of the predetermined thing or the predetermined material in response to the set event to effect the predetermined result at the occurrence timing as predicted, and
wherein the change of the predetermined thing or the predetermined material includes change of a position and/or an appearance.

11. The timing controller as claimed in claim 9, wherein the setting unit determines a change-start timing, appearance timing, change-start position, a trajectory, velocity, or acceleration of the predetermined thing or the predetermined material on the basis of the occurrence timing as predicted, and sets the event on the basis of a result of the determination.

12. The timing controller as claimed in claim 1, wherein the setting unit sets the event a predetermined time prior to the occurrence timing as predicted, and
wherein the controlling unit starts the predetermined control in response to the set event to effect the predetermined result after elapse of the predetermined time.

13. The timing controller as claimed in claim 12, wherein the predetermined control is control of a predetermined image,
wherein the controlling unit starts change of the predetermined image in response to the set event to allow the predetermined image to effect the predetermined result after elapse of the predetermined time, and
wherein a process of the change of the predetermined image does not depend on the audio signal.

14. The timing controller as claimed in claim 13, wherein the controlling unit sets speed of the change of the predetermined image to a constant value without depending on the audio signal.

15. The timing controller as claimed in claim 12, wherein the predicting unit predicts the occurrence timing of the base point of the cyclic repetition of the audio signal on the basis of a frequency and a phase of the cyclic repetition of the audio signal, and the predetermined time.

16. The timing controller as claimed in claim 15, wherein the predicting unit comprising:
a converting unit operable to convert the audio signal from a time domain to a frequency domain;
a frequency detecting unit operable to detect a peak value from the audio signal as converted to the frequency domain to regard a frequency of the peak value as a frequency of the cyclic repetition of the audio signal;
a phase detecting unit operable to detect a phase of a peak value of the audio signal with time of a predetermined clock as a criterion to regard the phase of the peak value as a phase of the cyclic repetition of the audio signal; and
a unit operable to predict the occurrence timing of the base point of the cyclic repetition of the audio signal on the basis of the frequency and the phase of the cyclic repetition of the audio signal, and the predetermined time.

17. The timing controller as claimed in claim 1, wherein the predicting unit corrects a result of the prediction of the occurrence timing of the base point of the cyclic repetition of the audio signal in accordance with a shift of a phase of the audio signal.

18. The timing controller as claimed in claim 1, wherein the predicting unit corrects the currently predicted occurrence timing of the base point of the cyclic repetition to more retarded timing when an absolute value of a difference between the currently predicted occurrence timing of the base point of the cyclic repetition and the previously predicted occurrence timing of the base point of the cyclic repetition is smaller than a value obtained by multiplying a cycle of the cyclic repetition by a first predetermined number, and/or corrects the currently predicted occurrence timing of the base point of the cyclic repetition to earlier timing when the absolute value of the difference is larger than a value obtained by multiplying said cycle by a second predetermined number, and
wherein the first predetermined number is larger than 0 and smaller than 1 while the second predetermined number is larger than 1 and smaller than 2.

19. The timing controller as claimed in claim 18, wherein the first predetermined number is 0.5 while the second predetermined number is 1.5, and
wherein the predicting unit corrects the currently predicted occurrence timing of the base point of the cyclic repetition to more retarded timing by a time period equal to said cycle when the absolute value of the difference is smaller than the value obtained by multiplying said cycle by the first predetermined number, and/or corrects the currently predicted occurrence timing of the base point of the cyclic repetition to earlier timing by a time period equal to said cycle when the absolute value of the difference is larger than the value obtained by multiplying said cycle by the second predetermined number.

20. The timing controller as claimed in claim 1, wherein the setting unit sets the event so that a time from time when the event is set until a time when the predetermined result is effected coincides with a cycle of the cyclic repetition of the audio signal.

21. The timing controller as claimed in claim 20, wherein the predetermined control is control of a predetermined image, and
wherein the controlling unit starts change of the predetermined image in response to the set event to allow the predetermined image to effect the predetermined result at the occurrence timing as predicted.

22. The timing controller as claimed in claim 1, wherein the predicting unit comprises a detecting unit operable to detect the cyclic repetition of the audio signal on the basis of amplitude of the audio signal.

23. The timing controller as claimed in claim 22, wherein the detecting unit detects a time from a base point to a base point of the cyclic repetition of the audio signal on the basis of the amplitude of the audio signal, and determines a cycle of the cyclic repetition on the basis of an occurrence frequency of said time as detected.

24. The timing controller as claimed in claim 22, wherein the detecting unit corrects the currently predicted occurrence timing of the base point of the cyclic repetition on the basis of amplitude of the audio signal near the previously predicted base point of the cyclic repetition.

25. The timing controller as claimed in claim 24, wherein the detecting unit corrects the currently predicted occurrence timing of the base point of the cyclic repetition by using, as a base point, time when maximum amplitude of the audio signal within a predetermined range including the previously predicted base point of the cyclic repetition arises.

26. The timing controller as claimed in claim 1, wherein the audio signal is input from an external recording medium recording the audio signal or a communication line.

27. The timing controller as claimed in claim 1, wherein the audio signal is input from a microphone which converts an audio signal into an electrical signal.

28. The timing controller as claimed in claim 3, wherein a plurality of the predetermined images is displayed.

29. The timing controller as claimed in claim 3, wherein the predetermined image is prepared anew for each event which is sequentially set on the basis of a result of the prediction.

30. A timing controlling method, comprising the steps of:
detecting cyclic repetition of an audio signal by analyzing the audio signal as input from outside to predict occurrence timing of a base point of the cyclic repetition;
setting an event on the basis of the occurrence timing as predicted; and
performing a predetermined control in response to the set event to effect a predetermined result at the occurrence timing as predicted.

31. A computer readable recording medium storing a computer program, the computer program causing a computer to:
detect cyclic repetition of an audio signal by analyzing the audio signal as input from outside to predict occurrence timing of a base point of the cyclic repetition;
set an event on the basis of the occurrence timing as predicted; and
perform a predetermined control in response to the set event to effect a predetermined result at the occurrence timing as predicted.
